(19) United States
(12) Patent Application Publication
(10) Pub. No.: US 2016/0019309 A1
(43) Pub. Date: Jan. 21, 2016

(54) MODIFYING DIGITAL CONTENT BASED UPON USAGE PATTERNS

(71) Applicant: Oracle International Corporation, Redwood Shores, CA (US)

(72) Inventors: Srinivasan Madhavan, Hyderabad (IN); Nagasubrahmanyam Kummaragunta, Vijayawada (IN); Sneha Kuncham Srinivas, Hyderabad (IN)

(73) Assignee: Oracle International Corporation, Redwood Shores, CA (US)

(21) Appl. No.: 14/662,065

(22) Filed: Mar. 18, 2015

Related U.S. Application Data
(60) Provisional application No. 62/026,476, filed on Jul. 18, 2014.

(51) Int. Cl. G06F 17/30; H04L 29/08

(52) U.S. Cl. CPC G06F 17/30893; H04L 67/22

(57) ABSTRACT

Techniques are disclosed for adapting digital content responsive to the manner in which the digital content is consumed by its users or consumers. Certain techniques are disclosed for changing the organization and/or behavior of a document, such as a webpage, in response to user interactions with the document. For example, the manner in which a webpage is consumed by its consumers is monitored and usage patterns determined therefrom. The webpage is then dynamically adapted or modified responsive to the usage patterns. In certain embodiments, the adaptations involve dynamically modifying the organization and/or behavior of the webpage responsive to the usage patterns. Since the usage patterns for different sets of users can be different, the modification made to the document for a first set of users may be different from the modifications made for a second set of users.

### CROSS-REFERENCES TO RELATED APPLICATIONS

The present application is a non-provisional of and claims the benefit and priority under 35 U.S.C. 119(e) of U.S. Provisional Application No. 62/026,476, filed Jul. 18, 2014, entitled “Adapting Digital Content Based Upon Usage Patterns,” the entire contents of which are incorporated herein by reference for all purposes.

The present application is related to the following concurrently filed applications, the entire contents of which are incorporated herein by reference for all purposes:

(1) U.S. Non-Provisional application Ser. No. ______, (Attorney Docket No: 88325-897081(150300US)) entitled “ADAPTING DIGITAL CONTENT BASED UPON USAGE PATTERNS” filed ______; and

(2) U.S. Non-Provisional application Ser. No. ______, (Attorney Docket No: 88325-914526(150310US)) entitled “MODIFYING THE ORDER OF ITEMS IN A DIGITAL DOCUMENT BASED UPON USAGE PATTERNS” filed ______.

### BACKGROUND

The present disclosure relates generally to adapting digital content responsive to the manner in which the digital content is consumed by its users or consumers. More particularly, techniques are disclosed for changing the organization and/or behavior of a document, such as a webpage, in response to user interactions with the document.

Different users interact with digital content in different ways. For example, a web application (e.g., a web application offered under the Software as a Service (SaaS) model) comprising multiple user interface webpages may be used or consumed differently by different users. Anticipating or forecasting how the end users will use the web application, for example, how the users will use a particular webpage, is generally a mirage and has eluded application designers for a long time. As a result, invariably, the design of a web application has to go through multiple iterations comprising receiving feedback from users on how the users use the webpages of the application, making changes to the webpages in response to the feedback, getting feedback on the changes, etc. before the application is suitable for use by multiple users. The cost of each such iteration is generally very high for the application vendor or application designer in terms of re-design, coding, testing, and application downtime caused by each iteration. Further, there is no guarantee that the iterations will produce changes suitable for multiple users because the user feedback could be selective and not comprehensive and worse could be error prone or not accurate.

The problem becomes even more aggravated and complicated when the application is being used by different sets of users. A first set of users may consume or use a webpage in a particular way that may be completely different from the way the same webpage is consumed or used by a second set of users. This creates a dilemma for webpage designers as to how to create a single webpage that works for different sets of users whose usage patterns may vary. Changes made to the webpage (or application in general) to suit one set of users may not suit a different set of users—a common solution that suits all users may thus not be achievable.

Some tools exist for determining how users interact with a website. For example, tools (e.g., heat chart utilities) provided by Crazy Egg, Inc. of La Mirada, Calif., to a certain extent, ascertain how end users interact with a website. While these tools may help the website provider become more knowledgeable about how webpages provided by the website are being consumed by different users, these tools do not provide a solution for how the same website (i.e., the same webpages) can be designed to suit the different users. The design of the webpages still has to go through multiple iterations, as discussed above.

Some tools exist that can track an individual user's interactions with a webpage during a session and make some very simple changes based upon the individual user's interactions for that session. For example, during a session, a user may select a particular item from an ordered list of selectable items provided by a drop-down menu on a webpage. The most recently user-selected item may then be made available for selection at the top of the drop-down menu on the webpage for that user during that session. Thus, such behavior is restricted to a particular session and to a particular user.

### BRIEF SUMMARY

The present disclosure relates generally to adapting digital content responsive to the manner in which the digital content is consumed by its users or consumers. Certain techniques are disclosed for changing the organization and/or behavior of a document, such as a webpage, in response to user interactions with the document.

In certain embodiments, the digital content may be served to consumers in the form of documents, such as webpages. A digital document may be served to multiple users who may interact with or consume the same document in different ways. The manner in which the digital content is consumed by its consumers is monitored and usage patterns determined therefrom. The digital content of the document is dynamically adapted or modified responsive to the usage patterns. In certain embodiments, the adaptations involve dynamically modifying the organization and/or behavior of a digital document responsive to the determined usage patterns.

In certain embodiments, a digital document may be served to multiple sets of users who may interact with or consume the same document in different ways. For each set of users, information is tracked and stored indicative of the manner in which the users in that set interact with the document. The interactions by one set of users may be different from interactions by a different set of users. Information related to the interactions by users in a set of users is collected and analyzed to determine one or more usage patterns for that set of users. The document may then be dynamically modified for that set of users based upon the usage patterns. In the simplest case, all the users can be considered to be part of the same set of users, i.e., there is just one set of users.

For example, when a user from a particular set requests a document, the interaction information previously stored for users from that particular set may be analyzed to determine one or more usage patterns for that document with respect to the particular users set. The usage patterns are then used to determine whether the organization and/or behavior of the document being requested are to be dynamically modified before the document is served to the requesting user. If so, a modified document is dynamically generated by making the one or more modifications to the document and the modified document is then served to the user. In this manner, prior interactions with the document by users in the particular set impact the modifications made to the document that is served in response to a future document request received from a user in that particular set.

In certain embodiments, even though the base document may be the same, the modifications made for one set of users may be different from the modifications made for a different set of users. In this manner, the document is dynamically modified for different sets of users based upon the manner in which the document is consumed by users in the different sets of users. In such an embodiment, the manner in which a document is dynamically modified and served to an individual requesting user is dependent upon the aggregate interactions of the multiple users in the set of users to which the individual user belongs and not just upon the interactions of the individual user to whom the document is being served. Accordingly, the interactions with a document made by one user from the set of users can impact modifications, if any, made to the same document before the document is served to a different user from the set of users.

Various techniques (e.g., methods, systems, non-transitory computer-readable storage memory storing a plurality of instructions executable by one or more processors, etc.) are described for adapting digital content responsive to the manner in which the digital content is consumed by its users or consumers. In certain embodiments, a computer system may receive a first document request requesting a document comprising a first section located in a first location within the document. For example, the first document request may be received from a first user using a client device. The computer system may then determine first user interactions information for a first plurality of users that includes the first user, the first user interactions information indicative of one or more prior interactions with the document by one or more users from the first plurality of users. Based upon the first user interactions information, the computer system may determine a first modification to be made to the document, the first modification including changing the location of the first section within the document from the first location to a second location that is different from the first location. A first modified version of the document may then be generated comprising the first modification, wherein the first section is placed in the second location in the first modified version of the document instead of in the first location. The first modified version of the document may then be communicated as a response to the first document request. For example, the first modified version of the document may be communicated to the client that originated the first document request and may be displayed to the first user.

In some embodiments, the document and the modified versions of the document, for example, the first modified version of the document, may be webpages. In alternative embodiments, the document and the modified versions of the document may include other types of digital documents.

A user receiving a modified document may or may not have previously interacted with the document. For example, in the above example, the first user belonging to the first plurality of users may or may not have previously interacted with the document being requested, i.e., the first user may or may not be included in the one or more users from the first plurality of users that have previously interacted with the document. In this manner, the user receiving the modified document gets the benefit of interactions with the document by other users in the first plurality of users.

Various different techniques may be used to determine the modification(s) to be made to a document. In certain embodiments, a first usage pattern for the document for the first plurality of users may be determined from the first user interactions information for the first plurality of users. A modification to be made to the document may then be determined based upon the identified first usage pattern. For example, the first usage pattern may indicate that the one or more users from the first plurality of users interact more frequently with the first section of the document than a second section of the document that is located above the first section in the document. As a result, the modification that is determined may include changing the location of the first section within the document such that the first section is now placed above the second section in the modified document.

In certain embodiments, generating the modified version of the document may comprise accessing and using information related to the structure and behavior of the requested document, such as determining or accessing a document object model (DOM) for the document. The document object model may represent an organization of multiple sections of the document including the first and second sections. The document object model may then be modified such that the first section is now located in a different location in the document relative to one or more other sections of the document, for example, the first section is now located above the second section in the document.

In certain embodiments, usage information may be tracked for multiple sets of users and modifications customized to specific sets of users. In such an embodiment, the modifications made for a first set of users may be different from the modifications made for a second different set of users for the same document. In this manner, the document that is provided to a user is based upon usage patterns of the particular set of users to which the user belongs. A user receiving a modified document need not have previously interacted with the document. For example, a second document request may be received requesting the same document as the first document request. The second document request may, for example, be received from a second user. The second user corresponding to the second document request may be determined. Second user interactions information for a second plurality of users including the second user and different from the first plurality of users may then be determined where the second user interactions information is indicative of one or more prior interactions with the document by one or more users from the second plurality of users. Based upon the second user interactions information, a second modification to be made to the document may be determined, the second modification being different from the first modification. A second modified version of the document may then be generated comprising the second modification. The second modified version of the document may then be communicated as a response to the second document request. For example, the second modified version of the document may be communicated to a client that originated the second document request and may be displayed to the second user.

In certain embodiments, the modifications that are made to a digital document may include changing the order of items in a document responsive to the manner in which the document is consumed by users. For example, a first document request may be received requesting a document comprising a plurality of items arranged according to a first order. The first document request may be received from a first user using a client device. The first user corresponding to the first document request is determined. First user interactions information for a first plurality of users including the first user is then determined, the first user interactions information indicative of one or more prior interactions with the document by one or more users from the first plurality of users. Based upon the first user interactions information, a first modification to be made to the document is determined, the first modification including changing the order of the plurality of items from the first order to a second order different from the first order. A first modified version of the document is then generated in which the plurality of items is ordered according to the second order. The first modified version of the document may then be communicated as a response to the first document request. For example, the first modified version of the document may be communicated to the client that originated the first document request and may be displayed to the first user. In some embodiments, the document and the modified versions of the document, for example, the first modified version of the document, may be webpages. In alternative embodiments, the document and the modified versions of the document may include other types of digital documents.

Various different techniques may be used to determine the ordering-related modification(s) to be made to a document. In certain embodiments, a first usage pattern for the document for the first plurality of users may be determined from the first user interactions information for the first plurality of users. A modification to be made to the document may then be determined based upon the identified first usage pattern.

Various different ordering-related modifications may be made. For example, in certain embodiments, the plurality of items in the document, prior to the modification, may be arranged according to the first order due to sorting of the plurality of items based upon a first sorting criterion. In the modified document, the plurality of items may be arranged according to the second order due to sorting of the plurality of items based upon a second sorting criterion different from the first sorting criterion.

As another example, the document may comprise a table. Prior to the modification, the plurality of items in the table may be arranged in the first order due to sorting of the plurality of items based upon a first sorting criterion. The modification may comprise using a second sorting criterion for sorting the plurality of items in the table instead of the first sorting criterion. Accordingly, the modified version of the document that is generated may comprise the plurality of items being sorted using the second sort criterion instead of the first sort criterion resulting in the plurality of items being ordered according to the second order.

As yet another example, the document may comprise a drop-down menu comprising a plurality of items arranged in the first order prior to the modification, where a first item in the plurality of items is placed in a first position in the first order. The modified version of the document may comprise the drop-down menu comprising the plurality of items arranged in the second order, wherein the first item is placed in a second position in the second order, the second position being different from the first position.

As another example, the document may comprise a field for receiving input and the plurality of items may be associated with the field and may be arranged in the first order. The modified version of the document may comprise the field and the associated plurality of items arranged according to a second order.

In certain embodiments, usage information may be tracked for multiple sets of users and ordering-related modifications customized to specific sets of users. In such an embodiment, the modifications made for a first set of users may be different from the modifications made for a second different set of users for the same document. In this manner, the document that is provided to a user is based upon usage patterns of the particular set of users to which the user belongs. A user receiving a modified document need not have previously interacted with the document. For example, a second document request may be received requesting the same document as the first document request. The second document request may, for example, be received from a second user. The second user corresponding to the second document request may be identified. Second user interactions information may be determined for a second plurality of users different from the first plurality of users, the second user interactions information indicative of one or more prior interactions with the document by one or more users from the second plurality of users, the second plurality of users including the second user. Based upon the second user interactions information, a second modification to be made to the document may be identified, the second modification being different from the first modification, the second modification including changing the order of the plurality of items from the first order to a third order different from the first order. A second modified version of the document may be generated comprising the second modification and the second modified version of the document communicated as a response to the second document request.

In an embodiment where multiple sets of users are monitored, usage patterns may be determined for each set of users and modifications to be made to the document determined based upon the determined usage patterns. For example, in the above example, where first and second modifications are determined for the same document, determining the first modification to be made to the document may comprise identifying, from the first user interactions information, a first usage pattern for the document for the first plurality of users, and determining the first modification to be made to the document based upon the identified first usage pattern. Determining the second modification to be made to the document may comprise identifying, from the second user interactions information, a second usage pattern for the document for the second plurality of users, wherein the second usage pattern is different from the first usage pattern, and determining the second modification to be made to the document based upon the identified second usage pattern.

In certain embodiments, the modifications that are made to a digital document may include automatically changing the value assigned to a field of a document responsive to the manner in which the document is consumed by users. For example, a first document request may be received requesting a document comprising an element, for example, an input field in the document. The first document request may be received from a first user using a client device. The first user corresponding to the first document request is determined. First user interactions information is determined for a first plurality of users including the first user, the first user interactions information indicative of one or more prior interactions with the document by one or more users from the first plurality of users. Based upon the first user interactions information, a first modification to be made to the document is determined, the first modification including associating a first value with the element. A first modified version of the document may then be generated in which the first value is associated with the element and the first modified version of the document is then communicated as a response to the first document request. For example, the first modified version of the document may be communicated to a client that originated the first document request and may be displayed to the first user. In some embodiments, the document and the modified versions of the document, for example, the first modified version of the document, may be webpages. In alternative embodiments, the document and the modified versions of the document may include other types of digital documents.

Various different techniques may be used to determine the modification(s) to be made to a document. For example, determining the first modification to be made to the document may comprise identifying, from the first user interactions information, a first usage pattern for the document for the first plurality of users, and determining the first modification to be made to the document based upon the identified first usage pattern.

In embodiments where multiple sets of users are tracked and modifications customized to specific sets of users, a second document request may be received requesting the same document as the first document request. The second document request may, for example, be received from a second user. The second user corresponding to the second document request is determined. Second user interactions information is determined for a second plurality of users including the second user and different from the first plurality of users, the second user interactions information indicative of one or more prior interactions with the document by one or more users from the second plurality of users. Based upon the second user interactions information, a second modification to be made to the document may be determined, the second modification being different from the first modification, the second modification including associating a second value with the element in the document, the second value being different from the first value. A second modified version of the document may then be generated comprising the second modification and the second modified version of the document communicated as a response to the second document request. In an embodiment where multiple sets of users are monitored, usage patterns may be determined for each set of users and modifications to be made to the document determined based upon the determined usage patterns.

In certain embodiments, a first document request may be received requesting a document comprising a plurality of tabs with a first tab from the plurality of tabs being selected. A first user corresponding to the first document request may be identified. First user interactions information may then be determined for a first plurality of users including the first user, the first user interactions information indicative of one or more prior interactions with the document by one or more users from the first plurality of users. Based upon the first user interactions information, a first modification to be made to the document may be determined, the first modification including selecting a second tab from the plurality of tabs instead of the first tab. A modified version of the document may then be generated in which the second tab from the plurality of tabs is selected instead of the first tab and the modified version of the document communicated as a response to the first document request.

The foregoing, together with other features and embodiments will become more apparent upon referring to the following specification, claims, and accompanying drawings.

### BRIEF DESCRIPTION OF THE DRAWINGS

FIG. 1 depicts a simplified high level diagram of a network environment that may incorporate an embodiment of the present invention.

FIG. 2 depicts a more detailed high level diagram of a client device and an adaptive webpages system according to an embodiment of the present invention.

FIG. 3 depicts a simplified flowchart depicting processing performed by an adaptive webpages system according to an embodiment of the present invention.

FIG. 4 depicts a simplified flowchart depicting processing performed for determining any modifications to be made to a webpage prior to the webpage being served to a requesting client according to an embodiment of the present invention.

FIGS. 5A, 5B, 6A, 6B, 7A, and 7B depict examples of modifications that may be made to a webpage according to an embodiment of the present invention.

FIGS. 8A and 8B provide a use-case example depicting the manner in which usage patterns may be used to dynamically modify a webpage according to an embodiment of the present invention.

FIG. 9 depicts another embodiment that may incorporate teachings of the present invention.

FIG. 10 depicts a simplified diagram of a distributed system for implementing an embodiment.

FIG. 11 is a simplified block diagram of one or more components of a system environment in which services may be offered as cloud services, in accordance with an embodiment of the present disclosure.

FIG. 12 illustrates an exemplary computer system that may be used to implement an embodiment of the present invention.

FIG. 13A depicts a portion of a DOM tree corresponding to the webpage depicted in FIG. 8A according to an embodiment of the present invention.

FIG. 13B depicts a portion of a modified DOM tree corresponding to a modified webpage depicted in FIG. 8B according to an embodiment of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

The present disclosure relates generally to adapting digital content responsive to the manner in which the digital content is consumed by its users or consumers. For purposes of this disclosure, it is assumed that the digital content is served to its consumers in the form of digital documents, such as webpages. A digital document may be served to multiple users who may interact with or consume the same document in different ways. The manner in which the digital content is consumed by its consumers is monitored and usage patterns determined therefrom. The digital content of the document is dynamically adapted or modified responsive to the usage patterns. In certain embodiments, the adaptations involve dynamically modifying the organization and/or behavior of a digital document responsive to the determined usage patterns.

In certain embodiments, a digital document may be served to multiple sets of users who may interact with or consume the same document in different ways. For each set of users, information is tracked and stored indicative of the manner in which the users in that set interact with the document. The interactions by one set of users may be different from interactions by a different set of users. Information related to the interactions by users in a set of users is collected and analyzed to determine one or more usage patterns for that set of users. The document may then be dynamically modified for that set of users based upon the usage patterns. In the simplest case, all the users can be considered to be part of the same set of users, i.e., there is just one set of users.

For example, when a user from a particular set requests a document, the interaction information previously stored for users from that particular set may be analyzed to determine one or more usage patterns for that document with respect to the particular users set. The usage patterns are then used to determine whether the organization and/or behavior of the document being requested are to be dynamically modified before the document is served to the requesting user. If so, a modified document is dynamically generated by making the one or more modifications to the document and the modified document is then served to the user. In this manner, prior interactions with the document by users in the particular set impact the modifications made to the document that is served in response to a future document request received from a user in that particular set.

For the same base document, the modification(s) made for one set of users may be different from the modification(s) made for a different set of users. In this manner, a document can be dynamically modified for different sets of users based upon the manner in which the document is consumed by users in the different sets of users. The manner in which a document is modified and served to an individual user is dependent upon the aggregate interactions of the multiple users in the set of users to which the individual user belongs and not just upon the interactions of the individual user to whom the document is being served. In such an embodiment, the interactions with a document made by one user from the set of users can impact modifications, if any, made to the same document before the document is served to a different user from the same set of users. A user receiving a modified document need not have previously interacted with the document.

For purposes of explanation, certain embodiments are described below where the documents are webpages that may be served to multiple users. The webpages may be part of a web-based application and may be served from a website. For example, a webpage comprising a user interface may be served to multiple sets of users, who may interact with or consume the webpage in different ways. For example, users from a first set of users may spend more time interacting with a certain portion of the webpage than other sets of users; users from another set of users may use certain user interface elements more frequently than other sets of users; yet another set of users may always sort a table on the webpage using a criterion that is different from the default sorting criterion for the table, and the like.

In certain embodiments, information may be tracked and stored for the different sets of users. The tracked information for a set of users may indicate the manner in which users in that set of users interact with the webpage. The stored interactions information for a set of users may then be used to determine usage patterns for the set of users. The usage patterns for the set of users are then used to identify modifications, if any, to be made to the webpage, when serving the webpage to a user from the set of users. The modifications to be made may include modifying the webpage organization and/or behavior. In such an embodiment, a subsequent webpage request from a user from the set of users may result in the modified webpage being served to the user in response. In this manner, prior interactions with the webpage by users in a particular user set are used to dynamically determine and make modifications to the webpage and the modified webpage is then served in response to a subsequent webpage request received from a user in the particular user set.

While certain embodiments have been disclosed describing how the organization and behavior of webpages can be dynamically modified responsive to the manner in which end-users interact with the webpages, this is not intended to be restrictive. In addition to webpages, the teachings disclosed herein can also be applied to other types of digital documents. The teachings are applicable to any application (e.g., web applications) that serves digital content in the form of documents to end-users.

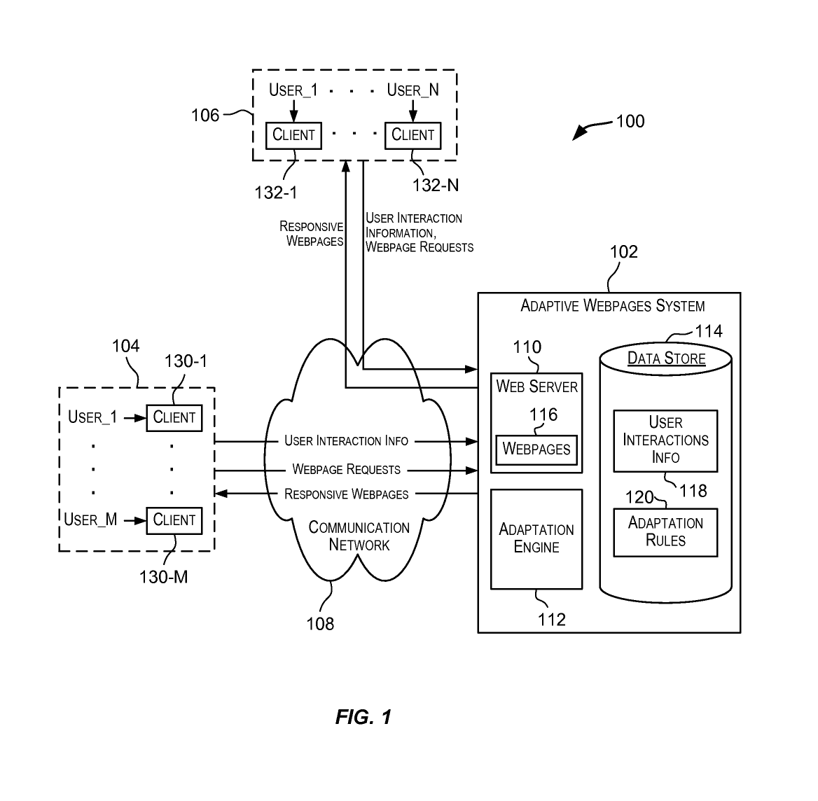

FIG. 1 depicts a simplified high level diagram of a network environment 100 that may incorporate an embodiment of the present invention. As shown, network environment 100 comprises multiple client devices 130-1-130-M and 132-1-132-N communicatively coupled to an adaptive webpages system 102 via a communication network 108. The embodiment depicted in FIG. 1 is merely an example and is not intended to unduly limit the claimed embodiments of the present invention. One of ordinary skill in the art would recognize many variations, alternatives, and modifications. For example, there may be more or less client devices, networks, and adaptive webpages systems than those shown in FIG. 1.

The client devices depicted in FIG. 1 may be of various different types, including, but not limited to personal computers, desktops, mobile or handheld devices such as laptops, smart phones, tablets, etc., and other types of devices. A user may use a client device to request a document. The requested document may then be communicated or served to the user in response to the document request. The document may then be output or displayed to the user via the client device.

Communication network 108 facilitates communications between the client devices and adaptive webpages system 102. Communication network 108 can be of various types and can include one or more communication networks. Examples of communication network 108 include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk®, Bluetooth®, and other protocols. In general, communication network 108 may include any infrastructure that facilitates communications between clients and adaptive webpages system 102.

A user may request a webpage using a client device. If the requested webpage is one from webpages 116 hosted by web server 110 monitored by adaptive webpages system 102, then the webpage request is communicated from the client device to adaptive webpages system 102. Upon receiving such a webpage request, adaptive webpages system 102 is configured to determine a webpage corresponding to the webpage request to be sent to the requesting client in response. Adaptive webpages system 102 then determines whether the determined webpage is to be modified prior to sending the webpage to the requesting client. Upon determining that the webpage is to be modified, adaptive webpages system 102 determines the specific one or more modifications to be made to the webpage. In certain embodiments, adaptive webpages system 102 determines whether a webpage is to be modified and the modifications to be made based upon one or more usage patterns determined by adaptive webpages system 102 for a set of users to which the requesting user belongs. In one embodiment, adaptive webpages system 102 determines the usage patterns for the set of users and the modifications to be made based upon user interactions information 118 stored by adaptive webpages system 102 for the set of users to which the requesting user belongs and based upon adaptation rules 120. Upon determining that the webpage is to be modified, adaptive webpages system 102 is configured to dynamically create a modified webpage that includes the determined modifications. Adaptive webpages system 102 is then configured to communicate the modified webpage to the requesting client in response to the webpage request. Upon receiving the webpage communicated by adaptive webpages system 102, the modified webpage may be output to the requesting user via an output interface (e.g., a screen) of the client device.

In certain embodiments, a user may use a program or application executed by the user's client device to configure a webpage request. An example of such a program is a web browser, which may be used to generate webpage requests and output webpages received in response to the requests. For example, a user may request a webpage by providing a Uniform Resource Locator (URL) corresponding to the desired webpage to the browser or by taking an action (e.g., clicking on a URL) that invokes a URL corresponding to the webpage. This causes the browser to generate a webpage request that is then communicated to the web server hosting the website comprising the particular webpage. A webpage received by the browser in response to the webpage request is then loaded and output to the user by the browser. Examples of browsers include without restriction various versions of Windows Internet Explorer® (IE), Apple Safari®, Google Chrome™, Mozilla Firefox®, Opera™, and others.

Once a webpage has been received and output by a browser on a client, the user of the client device may interact with the webpage in various ways using one or more input mechanisms provided by the client device. These input mechanisms may include, for example, a mouse, a keyboard, touch-based input mechanism, audio inputs, and the like. According to certain embodiments, the user's interactions with the webpage are monitored and information indicative of the user's interactions is communicated from the client device to adaptive webpages system 102. Adaptive webpages system 102 may store the received interactions information as user interactions information 118.

Various different user interactions may be monitored. Examples include: tracking sections of the webpage that are viewed by the user and for how long; information entered by the user into one or more input fields on the webpage; interactions made by the user with user interface elements of the webpage such as clicking a button on the webpage, invoking a drop-down menu list and selecting a particular item from the list, sorting or filtering of contents on the webpage (e.g., sorting or filtering of table contents using one or more sorting or filtering criteria); and the like. In certain embodiments, various input events associated with the webpage may be monitored such as mouse-related events (e.g., mouse click, double click, mouse leftclick, mouse rightclick, mousedown, mouseup, double click, mouseover, mouseout, drag,), keyboard related events (e.g., keydown, keypress, keyup), touch-based events (e.g., tap, drag, pinch, double tap, touchstart, touchend, touchmove, single-touch, multi-touch), and the like. The information that is communicated from the client device to adaptive webpages system 102 may include information identifying, for each such monitored event, the type of event and context information for the event (e.g., the time when the event occurred, the portion of the webpage over which the event occurred, the target of the event). The interaction information for a user may be communicated from the client device to adaptive webpages system 102 upon the occurrence of an event or on a periodic basis. Adaptive webpages system 102 may receive interaction information from multiple users from multiple devices.

In some embodiments, various analysis tools may also be used to collect user interactions information. For example, tools provided by Crazy Egg, Inc. of La Mirada, Calif. may be used to capture a user's webpage interactions. The tool may then be configured to communicate the captured user interactions information to adaptive webpages system 102.

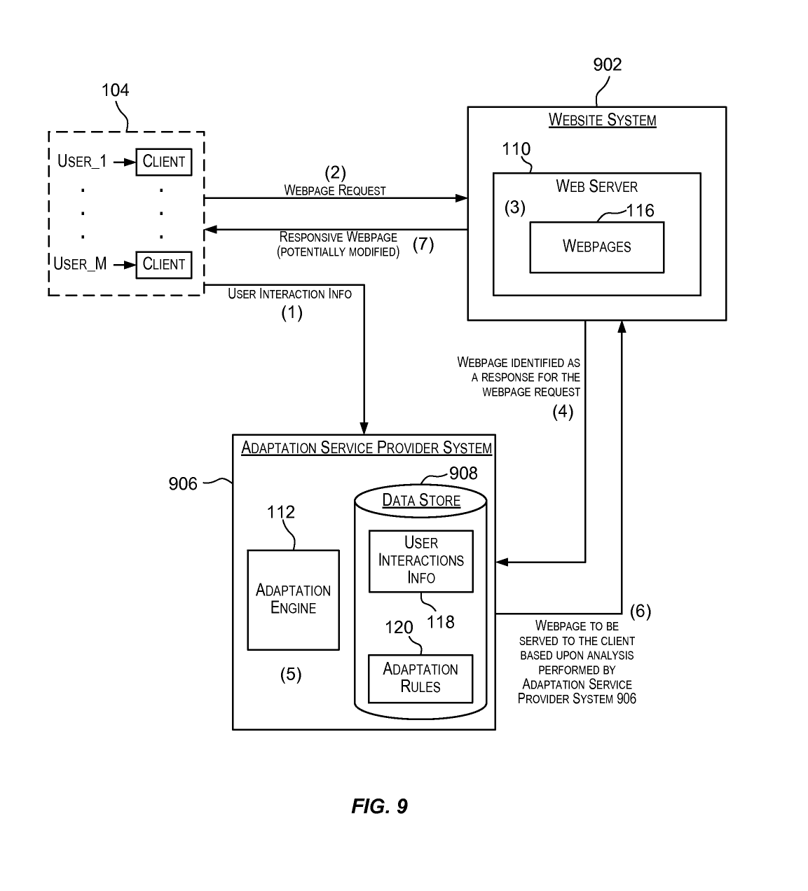

In the embodiment depicted in FIG. 1, adaptive webpages system 102 is configured to both host webpages 116 that are served in response to webpage requests received from clients and also to perform processing related to dynamic modifications of the webpages. This embodiment is however not intended to be limiting. Other embodiments are also possible, for example, the embodiment depicted in FIG. 9 and described below.

In the embodiment depicted in FIG. 1, adaptive webpages system 102 comprises a web server 110 that is configured to host webpages 116 and handle webpage requests and an adaptation engine 112 that is configured to perform processing related to dynamic modifications of the webpages. Adaptive webpages system 102 also comprises a data store 114 that is accessible to web server 110 and adaptation engine 112. Data store 114 provides a storage repository for storing information used by adaptive webpages system 102.

Web server 110 and adaptation engine 112 may be implemented in software (e.g., program code, instructions executable by one or more processing units), in hardware, or combinations thereof. In some embodiments, the software may be stored in memory (e.g., a non-transitory computer-readable medium), on a memory device, or some other physical memory and may be executed by one or more processing units (e.g., one or more processors, one or more processor cores, one or more GPUs, or combinations thereof).

Adaptive webpages system 102 may host one or more websites, each website comprising one or more webpages. In certain embodiments, web server 110 is configured to handle webpage requests received from one or more clients. Web server 110 is configured to receive a webpage request from a client and respond by communicating the corresponding webpage to the requesting client. As part of its processing, upon receiving a webpage request from a client, web server 110 is configured to determine a webpage corresponding to the webpage request. Web server 110 then uses the services of adaptation engine 112 to determine whether the determined webpage is to be modified. If the webpage is to be modified, then a modified webpage created by adaptation engine 112 is communicated by web server 110 in response to the webpage request. If the webpage is not to be modified, the webpage determined by web server 110 for the webpage request is sent to the client without any modifications.

Adaptation engine 112 is configured to perform processing related to determining whether a webpage is to be modified and, if so, to dynamically modify the webpage before the webpage is served in response to a webpage request. In certain embodiments, adaptation engine 112 is configured to receive user interaction information from various clients and store the information in data store 114 as user interactions information 118. For example, adaptation engine 112 may receive information from one or more client devices related to user interface events monitored at the client devices related to users' interactions with one or more webpages and save this information in data store 114 for further analysis.

In certain embodiments, adaptive webpages system 102 is configured to track and store information for different sets of users. In such an embodiment, adaptive webpages system 102 may receive user interactions information from several different client devices used by different users, who may potentially belong to different sets of users. For example, in the embodiment depicted in FIG. 1, adaptive webpages system 102 may be configured to track and store information for two sets of users 104 and 106. Adaptive webpages system 102 may receive interactions information from client devices of users belonging the first set of users 104 and users belonging to the second set of users 106. In one embodiment, stored user interactions information 118 may be organized such that the interactions information for any particular set of users is easily identifiable by and accessible to adaptation engine 112.

Adaptation engine 112 uses user interactions information 118 and adaptation rules 120 to determine whether a webpage requested by a client is to be modified and, if so, the nature of the modification(s). In certain embodiments, after web server 110 has identified a webpage corresponding to a webpage request received by adaptive webpages system 102, adaptation engine 112 uses user interactions information 118 and adaptation rules 120 to determine what modifications, if any, are to be made to the webpage before sending it to the requesting client. For a webpage to be modified, adaptation engine 112 is configured to dynamically create a modified version of the webpage comprising the modifications, and forward the modified webpage to web server 110 for sending to the requesting client in response to the webpage request.

Adaptation rules 120 comprise rules that are used by adaptation engine 112 to determine whether a webpage is to be modified, and if so, to determine the modifications to be made to a webpage for a set of users. In certain embodiments, adaptation rules 120 are configurable and may be configured by a system administrator of adaptive webpages system 102. In certain embodiments, the same adaptation rules 120 are applicable to different sets of users. In some other embodiments, adaptation rules 120 may be customized to specific sets of users.

Adaptation rules 120 can be provided in various different forms. In certain embodiments, adaptation rules may be configurable at different levels of granularity. For example, in one embodiment, the modifications that adaptive webpages system 102 is capable of making may be categorized into one or more categories and a set of adaptation rules may be configured for each category. For example, the categories may include default modifications, behavioral modifications, navigational suggestions or modifications, and the like.

In certain embodiments, adaptation rules may be specified and associated with a category that can turn on or off that category of modifications. In this manner, specific types of modifications can be turned ON or OFF by specifying the appropriate adaptation rules. In some other embodiments, adaptations rules may also be specific at a more granular level for each category of modification, such as specifying the modifications that can be made under a category.

As described above, modifications are made to a webpage responsive to past user interactions with the webpage. In some embodiments, thresholds may be associated with the user interactions, such that a modification responsive to an interaction is triggered only if the threshold (e.g., a number of times that the interaction occurred) associated with that interaction is exceeded. In certain embodiments, adaptation rules 120 may also be used to specify the user interaction thresholds. For example, the number of times users have interacted with a particular section of a webpage may be counted and a responsive modification triggered only after the number exceeds a pre-configured threshold.

A digital document such as a webpage may comprise multiple components. Examples of components include, without limitation, a title of the document, a body of text (e.g. paragraphs, grouping of lines), tables, menu items, buttons, form-fill fields (e.g., an input box), tabs, and the like. In certain embodiments, adaptation rules 120 may be specified at the webpage component level to control modifications to be made to that component. In one embodiment, for a component, adaptation rules may be specified for modifying different attributes or behaviors of the component in response to certain interactions. For example, for an attribute of a component, one or more rules may be specified identifying the type of modification to be performed in response to the existence of a certain condition. For example, if the component is a table, then rules may be specified identifying how the sorting, filtering, etc., attributes or behaviors of the table are to be modified in response to certain conditions such as what was used as the sorting or filtering criteria in prior interactions by a set of users. As an example, a rule may be specified indicating that, for a set of users, if a particular sorting criterion, which is different from the default table sorting criterion, has been selected at least “X” times in the past by users from the set of users, then for a subsequent webpage request, the table is to be sorted using the particular sorting criterion instead of the default sorting criterion. In this manner, rules may be specified directed to specific components of a webpage identifying one or more conditions when a component is to be modified, a specific attribute or behavior of the component to be modified, and the modification to be made. The rules may be same as or different for different sets of users.

Adaptive webpages system 102 shown in FIG. 1 is only one example of a system that may incorporate an embodiment of the invention. In some other embodiments, adaptive webpages system 102 may have more or fewer components than shown in FIG. 1, may combine two or more components, or may have a different configuration or arrangement of components. Adaptive webpages system 102 can be implemented using one or more computer systems including, without limitations, a personal computer, a portable device (e.g., a mobile telephone or device), a workstation, a network computer, a mainframe, a kiosk, a server, or any other data processing system. In some other embodiments, adaptive webpages system 102 may be configured as a distributed system where one or more components of system 102 are distributed across one or more networks in the cloud, for example, as depicted in FIG. 9 and described below.

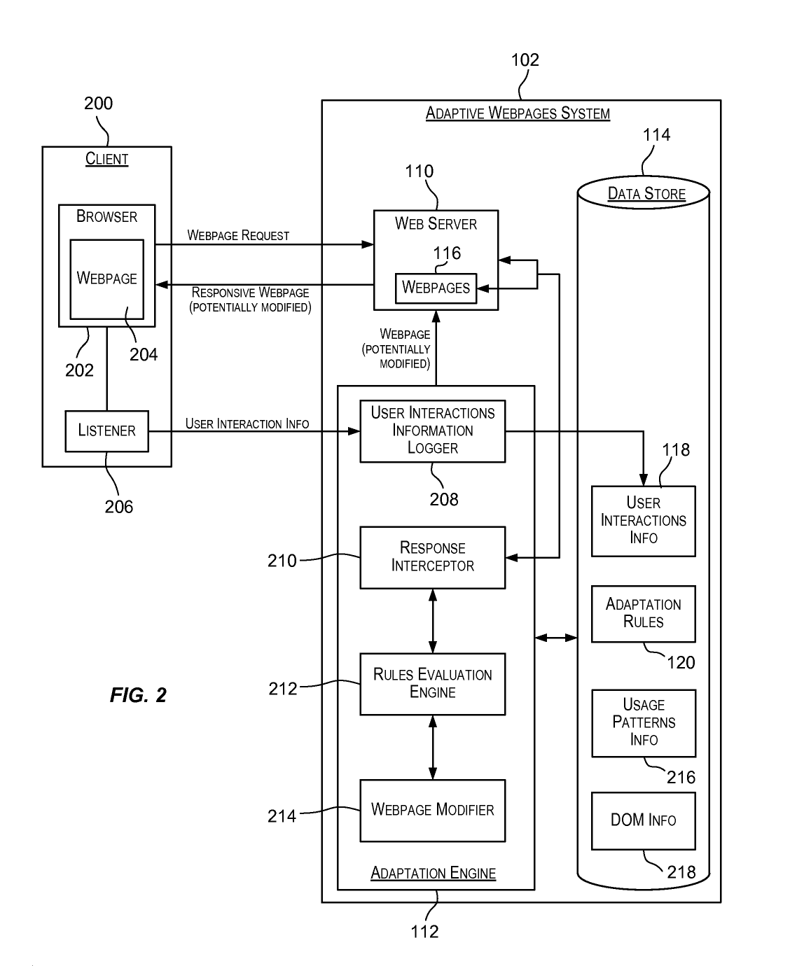

FIG. 2 depicts a more detailed high level diagram of a client device 200 and adaptive webpages system 102 according to an embodiment of the present invention. As shown in FIG. 2, adaptation engine 112 comprises several subsystem or modules including a user interactions information logger 208, a response interceptor 210, a rules evaluation engine 212, and a webpage modifier 214. These subsystems may be implemented in software (e.g., program code, instructions executable by a processor), in hardware, or combinations thereof. In some embodiments, the software may be stored in memory (e.g., a non-transitory computer-readable medium), on a memory device, or some other physical memory and may be executed by one or more processing units (e.g., one or more processors, one or more processor cores, one or more GPUs, or combinations thereof).

As depicted in FIG. 2, client device 200 may execute a web application such as browser 202 that enables a user of client device 200 to request and view webpages 204. Webpage requests generated by browser 202 are communicated to web server 110 of adaptive webpages system 102. Webpages sent by web server 110 of adaptive webpages system 102 in response to the webpage requests are received by browser 202, which then loads and outputs the webpages to the user of client 200.

Additionally, as depicted in FIG. 2, client device 200 may execute a listener program 206 that facilitates the monitoring and collection of information related to the user's interactions with webpages loaded and displayed by browser 202 and the communication of the user interactions information to adaptive webpages system 102. In certain embodiments, listener 206 may be implemented as a JavaScript code snippet that is injected into the HTML code for a webpage and executed by browser 202 when the webpage is loaded by browser 202. Listener 206 can be configured to monitor various interaction events (examples of which have been previously described) and communicate interactions information related to the monitored events to adaptive webpages system 102. In one embodiment, listener 206 listens to all actions that the end user performs on the webpage and posts information related to events resulting from the actions back to adaptation engine 112 asynchronously so that the performance of the webpage and the web application is not impacted. The monitoring, collection, storage, and communication of the user interactions information may be performed asynchronously from the processing performed by adaptive webpages system 102 related to processing of webpage requests.

In certain embodiments, listener 206 can access and track information related to the organization of a webpage and use this information to monitor a user's interactions with the webpage. For example, listener 206 may track the Document Object Model (DOM) for a webpage and use the DOM to identify which components or regions of the webpage have been clicked upon, selected, etc. The DOM is a platform- and language-neutral object-oriented representation of a webpage including the webpage's contents and their organization and attributes and the webpage's behavior. This information may then be communicated by listener 206 to adaptive webpages system 102.

On the adaptive webpages system 102 side, the interactions information communicated from client device 200 is received by user interactions information logger 208 that is configured to store the received information as user interactions information 118 in data store 114. User interactions information logger 208 may receive user interactions information from several different client devices corresponding to interactions by different users.

Adaptive webpages system 102 is capable of dynamically modifying webpages on a per user set basis for multiple sets of users. The manner in which a webpage is consumed or used by one set of users may be different from the way the same webpage is consumed by a different set of users. As a result, the modifications made to a webpage for one set of users may be different from the modifications made to the same webpage for a different set of users. To facilitate tracking of user interactions information and modifications on a per user set basis, in certain embodiments, user interactions information 118 stored in data store 114 is organized by user sets such that adaptation engine 112 can easily identify and access the user interactions information 118 for a particular set of users. Accordingly, in certain embodiments, upon receiving interactions information from a client device, user interactions information logger 208 is configured to determine a particular set of users corresponding to the received information and store the received user interactions information as part of information for that particular set of users.

Upon receiving a webpage request from a client, web server 110 is configured to determine a webpage corresponding to the webpage request from webpages 116. The webpage determined by web server 110 is then forwarded to adaptation engine 112 for performing analysis related to determining whether the webpage is to be modified prior to sending it to the requesting client. In one embodiment, the webpage determined by web server 110 for an incoming webpage request is intercepted by response interceptor 210 of adaptation engine 112. Response interceptor 210 then calls upon the services of rules evaluation engine 212 to perform analysis to determine whether the intercepted webpage is to be modified prior to sending the webpage to the requesting client device in response to the webpage request.

Rules evaluation engine 212 is responsible for determining whether the intercepted webpage is to be modified, and, if so, the one or more modifications to be made to the webpage. In one embodiment, rules evaluation engine 212 performs this processing based upon adaptation rules 120 that encode the logic to be used for making decisions regarding the modifications of the webpage. Adaptation rules 120 are configurable by a user or administrator of adaptive webpages system 102. Different sets of adaptation rules 120 may be configured for different sets of users.

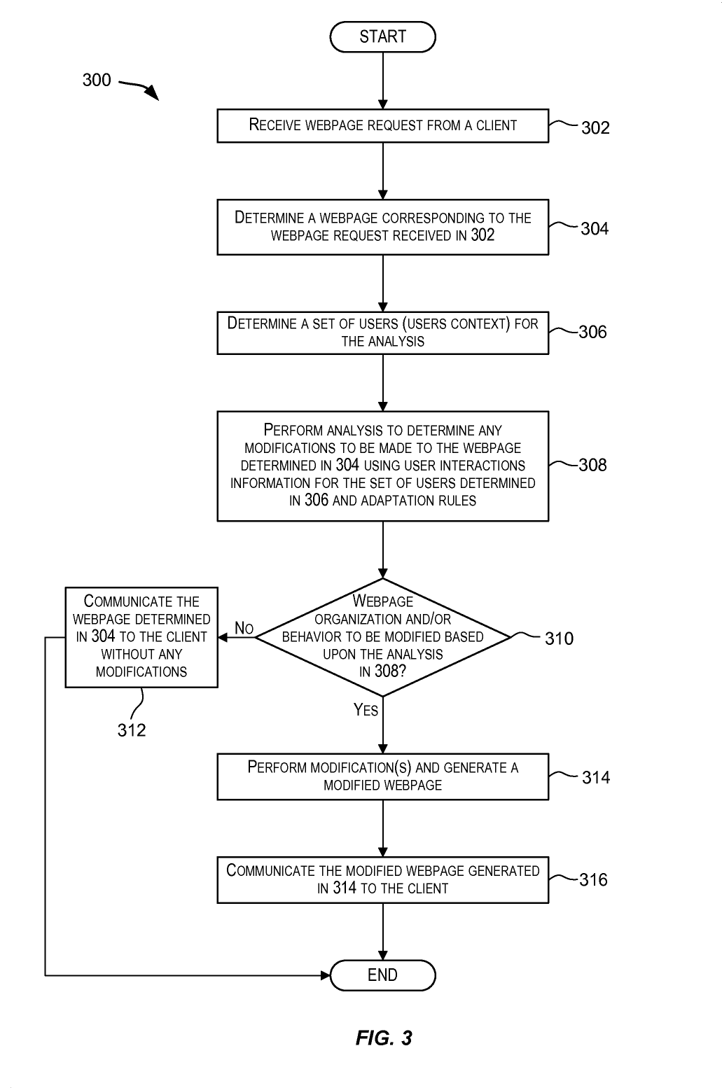

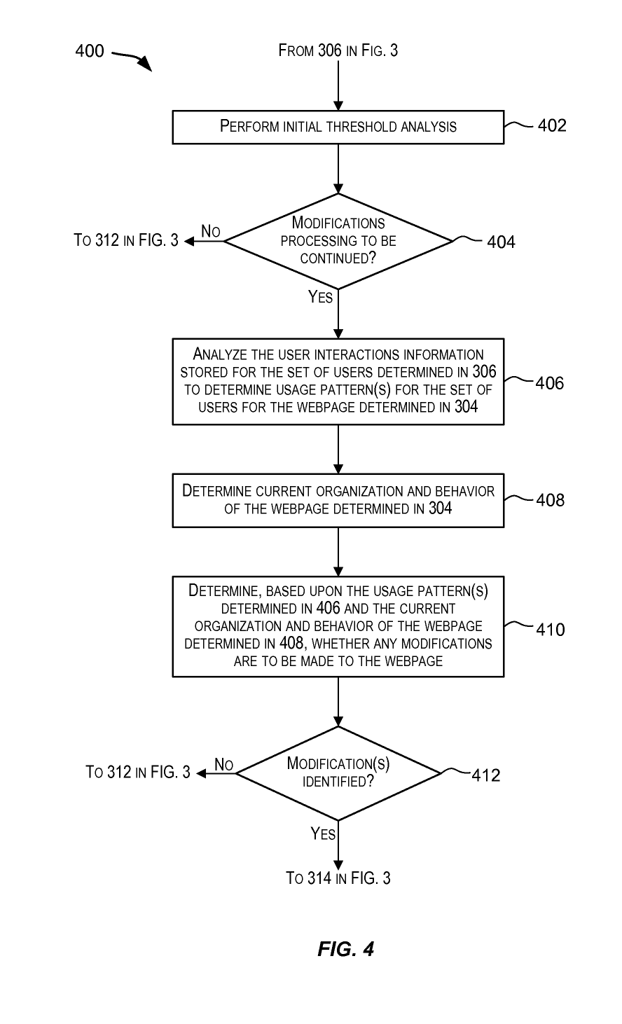

As part of its processing, in certain embodiments, rules evaluation engine 212 is configured to: (1) determine, based upon the requesting user, a specific set of users for which analysis is to be performed; (2) determine, based upon the user interactions information collected for the specific set of users, one or more usage patterns (which may be stored as usage patterns information 216 in data store 114) for the set of users with respect to the requested webpage; (3) determine the existing organization and behavior of the webpage; (4) determine any modifications to be made to the webpage based upon the determined usage patterns information, the existing organization and behavior of the webpage, and adaptation rules 120; (5) if a modification is to be made, use the services of webpage modifier 214 to create a modified webpage incorporating the identified modifications; and (6) forward the modified webpage to web server 110 for forwarding to the requesting client. If it is determined instead that the webpage is not to be modified, then adaptation engine 112 may send a signal to web server 110 indicating that no modification is to be performed. Upon receiving the “no modification” signal, web server 110 may then send the webpage determined by web server 110 to the requesting client without any modifications. Further details related to processing performed by adaptation engine 112 are depicted in FIGS. 3 and 4 and described below.

Rules evaluation engine 212 may use various different techniques to determine the existing or current organization and behavior of the webpage. In one embodiment, rules evaluation engine 212 may use the Document Object Model (DOM) for the webpage to determine the existing organization and behavior of the webpage. DOM information 218 corresponding to the webpage may be stored in data store 114 and accessed by rules evaluation engine 212 for this analysis. In another embodiment, rules evaluation engine 212 may be configured to create the DOM for the webpage identified by web server 110 based upon the HTML code for the webpage. When a modification is to be made to a webpage, rules evaluation engine 212 determines how the DOM for the webpage is to be modified and forwards the modification suggestions to webpage modifier 214, which is then configured to perform the modifications and generate a modified webpage.

The DOM for a webpage is a platform- and language-neutral object-oriented representation of the webpage including the webpage's contents and their organization and attributes and the webpage's behavior. In one embodiment, the DOM standard put forth by the W3C standards organization may be used. Each webpage is composed of a series of HTML elements that may be nested. The DOM for a webpage is generally constructed as a tree of nodes or objects, with the nodes representing various components (e.g., header, paragraph, tables, form field, drop-down menu, sections of a webpage, etc.) of the webpage.

In certain embodiments, the nodes or objects in a DOM include a document node that forms the root of the DOM tree and represents the webpage document. Every component (e.g., HTML element) in the webpage is represented as an element node. HTML attributes of the webpage are represented as attribute nodes in the DOM tree. Comments in the webpage are represented as comment nodes in the DOM tree. In this manner, the nodes of the DOM tree represent various elements, attributes, comments, behavior, etc. of the webpage. For example, a table on a webpage may be represented by a node in the DOM and the sort criterion for the table may be specified as an attribute associated with the node. The DOM standard put forth by the W3C standards organization provides several APIs for building a DOM, accessing a DOM and its nodes, and modifying a DOM. The DOM specification is not restricted to just a webpage; a DOM or an equivalent modeling scheme may be used for specifying the organization and behavior of other types of digital documents. In some embodiments, other types of techniques or specifications other than a DOM may be used for modeling and specifying the structure and behavior of a document. In such embodiments, these other techniques or specifications may be used for making modifications to a document.

The nodes in a DOM tree generally have a hierarchical relationship to each other with the document node representing the root of the DOM tree. The nodes hierarchy in the DOM tree reflects the relationships between the various HTML elements in the webpage. The terms parent, child, and sibling may be used to describe the hierarchical relationships between the nodes in the DOM tree. Each node in the DOM tree, except the root node, has exactly one parent node. A node can have zero or more children nodes. Nodes having the same parent node are referred to as sibling nodes.

In certain embodiments, rules evaluation engine 212 may use the DOM information for a webpage to determine the existing organization and behavior of the webpage. After rules evaluation engine 212 has determined that modifications are to be made to the webpage, rules evaluation engine 212 may forward information identifying the modifications to webpage modifier module 214 that is configured to create a modified version of the webpage incorporating those modifications. In one embodiment, webpage modifier 214 is configured to make the webpage modifications by making modifications to the DOM for the webpage. Webpage modifier 214 may use different standard DOM APIs to make changes to the DOM for the webpage. Webpage modifier 214 may then create a modified version of the webpage using the modified DOM. Adaptation engine 112 may then forward the modified webpage to web server 110. Web server 110 may then send the modified webpage to the requesting client device in response to the webpage request received from the client device.

In certain embodiments, if the webpage is not modified, adaptation engine 112 may forward the unmodified webpage to web server 110. Web server 110 may then send the unmodified webpage to the requesting client device in response to the webpage request. In some embodiments, adaptive webpages system 102 may send a signal to web server 110 indicating that no modification is to be performed and web server 110 may then send the unmodified webpage determined by web server 110 to the requesting client.

From the client's perspective, client 200 receives a webpage in response to the webpage request. The received webpage is then output by client 200. For example, if the webpage request originated from browser 202 on client 200, then the webpage received in response to the webpage request is received by browser 202 and output by browser 202. For example, browser 202 may display the received webpage on a display of client 200. From the perspective of client 200 and browser 202, the processing for displaying a webpage, whether modified or not, is the same; client 200 and browser 202 do not need to do any special processing to display a modified webpage. For example, in some embodiments, browser 202 may parse the webpage contents and build a DOM tree for the webpage and then use the DOM tree to render or display the webpage. Accordingly, if the DOM representation for the webpage incorporates the modifications, those modifications are then displayed by browser 200 for that webpage.

FIG. 3 depicts a simplified flowchart 300 depicting processing performed by adaptive webpages system 102 according to an embodiment of the present invention. The processing depicted in FIG. 3 may be implemented in software (e.g., code, instructions, program) executed by one or more processing units (e.g., processors, cores), hardware, or combinations thereof. The software may be stored in memory (e.g., on a non-transitory computer-readable storage medium such as a memory device). The particular series of processing steps depicted in FIG. 3 is not intended to be limiting. It is appreciated that the processing steps may be performed in an order different from that depicted in FIG. 3, and that not all the steps depicted in FIG. 3 need be performed. In one embodiment, the processing depicted in FIG. 3 is performed by adaptive webpages system 102 depicted in FIGS. 1 and 2.

The processing in flowchart 300 is initiated, at 302, when adaptive webpages system 102 receives a webpage request from a client device. At 304, a webpage corresponding to the webpage request received in 302 is determined. For example, the webpage request received in 302 may identify a URL and a webpage corresponding to the URL may be determined in 304.

At 306, a set of users corresponding to the webpage request received in 302 is determined. Various different techniques may be used to determine the particular set of users. According to one technique, the determination is made based upon information contained in the webpage request received in 302. In some embodiments, the webpage request may comprise information identifying the source of the webpage request (e.g., a source IP address, a source domain identifier) and this information may be used to determine the client device where the request originated. This client device information may then be used to identify a user, which in turn may be used to identify the particular set of users in 306. In some embodiments, the webpage request may identify the user requesting the webpage and the user information may then be used to identify the relevant set of users. In yet some other embodiments, the webpage request received in 302 may itself include information that identifies a specific set of users. In one simple embodiment, all the users may be considered to be part of the same set of users, such that there is only one set of users.

At 308, analysis is performed to determine any modifications to be made to the webpage determined in 304. This analysis may be performed using user interactions information 118 stored for the set of users determined in 306 and based upon adaptation rules configured for the adaptive webpages system.

At 310, a determination is made as to whether the organization and/or behavior of the webpage determined in 304 are to be modified based upon the analysis performed in 308. If it is determined at 310 that no modifications are to be made to the webpage, then at 312, the webpage determined in 304 is communicated to the requesting client device without any modifications, and processing ends. On the other hand, if it is determined in 310 that, based upon the analysis performed in 308, one or more modifications to the organization and/or behavior of the webpage have been identified, then processing continues with 314. Further details related to the processing performed in 308 and 310 are described below in reference to flowchart 400 depicted in FIG. 4.

At 314, a modified webpage is created or generated that incorporates the one or more modifications identified in 308. In certain embodiments, the DOM for a webpage represents the structural representation of a webpage. In such an embodiment, the modified webpage is generated by modifying the DOM tree for the webpage determined in 304 such that the modified DOM incorporates the identified modifications. At 316, the modified webpage generated in 314 is communicated to the requesting client in response to the webpage request received from the client and processing ends. In some embodiments, other types of techniques or specifications other than a DOM may be used for modeling and specifying the structure and/or behavior of a document. In such embodiments, these other techniques or specifications may be modified for making modifications to a document.

The requesting client may then display the received webpage. In some embodiments, the client may parse the received webpage contents and build a DOM tree for the webpage and then use the DOM tree to render or display the webpage. Accordingly, if the DOM representation for the webpage incorporates the modifications, those modifications are then displayed for that webpage.

FIG. 4 depicts a simplified flowchart 400 showing processing performed for determining any modifications to be made to a webpage prior to the webpage being served to a requesting client according to an embodiment of the present invention. The processing depicted in FIG. 4 may be implemented in software (e.g., code, instructions, program) executed by one or more processing units (e.g., processors, cores), hardware, or combinations thereof. The software may be stored in memory (e.g., on a non-transitory computer-readable storage medium such as a on a memory device). The particular series of processing steps depicted in FIG. 4 is not intended to be limiting. It is appreciated that the processing steps may be performed in an order different from that depicted in FIG. 4, and that not all the steps depicted in FIG. 4 need be performed. In one embodiment, the processing depicted in FIG. 4 may be performed as part of the processing performed in 308 and 310 in FIG. 3 and may be performed by rules evaluation engine 212 and webpage modifier 214 depicted in FIG. 2.

In certain embodiments, the modifications-related processing performed by adaptive webpages system 102 may be broken down into two phases:

(1) An initial phase during which an initial threshold analysis is performed to determine if the webpage is eligible for dynamic organization and/or behavior modification; and
(2) If the initial phase is successfully passed, i.e., the webpage is eligible for dynamic organization and/or behavior modification, a second phase in which further analysis is performed to determine what specific modifications to make.

Accordingly, at 402 in flowchart 400, an initial phase analysis is performed to determine if the webpage determined in 304 in FIG. 3 is eligible for dynamic organization and/or behavior modification. Various factors may determine whether or not the webpage is eligible for modifications. For example:

(a) In certain embodiments, only some of the webpages provided by a website may be eligible for modifications. In other words, not all the webpages provided by a website may be eligible for dynamic modifications. Accordingly, as part of the processing in 402, a check may be made to determine if the specific webpage determined in 304 is eligible for dynamic modification. If not eligible, then there is no need to perform any further modification-related analysis.
(b) In some scenarios, a webpage may be eligible for dynamic modification but only for specific sets of users. In other words, the webpage may not be eligible for dynamic modifications for certain set(s) of users. In such a scenario, as part of the processing in 402, an initial determination may be made as to whether the specific webpage determined in 304 is eligible for dynamic modification for the set of users determined in 306. If not, then there is no need to perform any further modification-related analysis.
(c) In some scenarios, even if the webpage determined in 304 is eligible for dynamic modification for the set of users determined in 306, there may not be sufficient historical user interactions information collected for the specific webpage for the specific set of users to perform any meaningful modification analysis. Accordingly, as part of the processing in 402, a check may be made to see if there is sufficient user interactions information for the specific webpage for the specific set of users to provide a modification recommendation. If not, then there is no need to perform any further modification-related analysis.
(d) In certain embodiments, the dynamic modification capability can be switched “on” or “off” at the granularity of a webpage and/or at the granularity of a set of users. Information may be stored by adaptive webpages system 102 indicating whether the dynamic modifications capability has been turned “on” or “off” for the specific set of users or for the specific webpage. Accordingly, as part of the processing in 402, a check may be performed to determine whether the modification capability has been turned “off” for either the webpage determined in 304 or for the set of users determined in 306. If either is turned “off,” then there is no need to perform any further modification-related analysis.

Accordingly, various checks may be performed in 402 as part of the initial threshold processing as to whether the webpage modifications-related processing is to be stopped or allowed to continue. At 404, a check is made to determine whether, based upon the analysis performed in 402, the modifications processing is to be continued. If it is determined in 404 that the processing is not to be continued, processing proceeds with 312 in FIG. 3 in which the webpage determined in 304 is communicated to the requesting client device without any modifications, and processing ends. If it is determined in 404 that the processing is to be continued, processing proceeds with 406 in FIG. 4.

At 406, the user interactions information stored for the set of users determined in 306 is analyzed to determine one or more usage patterns for the set of users with respect to the webpage determined in 304. For example, processing may be performed based upon the user interactions information to determine: if users from the set of users interact with a particular portion of the webpage more than other portions of the webpage; if the webpage comprises a sortable list (e.g., in a table), the criterion that is used most commonly by users in the set of users for sorting the list; if the webpage comprises a drop-down menu comprising a list of selectable items, the one or more items that are more frequently selected by users in the set of users; if the webpage comprises a fillable form field, the value that is most commonly input in that field by the users in the set of users; if the webpage comprises a fillable form field with an associated list of selectable options, the option that is most commonly selected by the users in the set of users for that field; and the like.

In one embodiment, the analysis to determine the usage patterns for a webpage for a set of users may be performed, as depicted in FIG. 4, as part of the processing performed upon receiving a webpage request for the webpage. In an alternative embodiment, in order to reduce the overall processing time in responding to a webpage request, processing for determining usage patterns may be performed by user interactions information logger 208 and/or rules evaluation engine 212 as and when user interactions information 118 is received by adaptive webpages system 102 and asynchronously or independent of the receipt of the webpage request. Information related to the determined usage patterns may be stored in data store 114 as usage patterns information 216, as depicted in FIG. 2. The stored usage patterns information 216 may then be accessed and used for the analysis in flowchart 400.

Rules evaluation engine 212 may use different techniques to determine one or more usage patterns for a set of users from user interactions information 118. According to one technique, the user interactions information for the set of users may be subjected to a clustering analysis to identify clusters of interactions, where each cluster identifies one or more instances of a similar interaction. For example, one cluster may correspond to changing the sort criterion for a table on the webpage from the default criterion to a specific different criterion. Another example of a cluster may correspond to the entry of a particular value in a particular form field on the webpage. Yet another cluster may correspond to interactions with a specific section of the webpage. A frequency count may then be allocated to each cluster, where the frequency count for a cluster indicates the number of times the interaction represented by the cluster was performed by users in the set of users. If the frequency count for a cluster exceeds some user-configurable threshold, then the activity represented by the cluster may be identified as a usage pattern. What constitutes a usage pattern may be specified using adaptation rules 120. For example, the cluster definitions and frequency counts associated with the clusters may be specified via one or more adaptation rules 120. While frequency is one way of determining a usage pattern, this is not meant to be restrictive. Various other data dimensions may be used to determine usage patterns and may be specified using adaptation rules 120.

Usage patterns are comparable to inferences made based upon the users interaction data collected for a set of users describing their interactions with a webpage, or an application in general. For example, user interactions with a drop-down list on a webpage may be monitored for the different kinds of values entered over a period of time by diverse users in a set of users. The usage information collected for interactions with the drop-down list can then be used to infer which value has been used most frequently over the period of time.

Further, the duration of a period used for determining a usage pattern can also be configured using adaptation rules 120. In certain embodiments, duration of time itself could be a variable in determining usage patterns. For example, the year may be broken down into two time periods—vacation time period (months June-August) and school year time period (January-May and September-December) and different usage patterns may be associated with the different time periods that may result in different modifications being made during the different time periods.

In certain embodiments, the identity of the users performing the interactions may also be considered in identifying a usage pattern and an associated modification recommendation. For example, in some scenarios, the interactions by certain users within a set of users may be given more weight than interactions by other users in the set of users in establishing usage patterns and determining webpage modifications to be made.

At 408, the current organization and behavior of the webpage identified in 304 is determined. Various different techniques may be used to determine the existing or current organization and behavior of the webpage. In one embodiment, information (e.g., DOM information) indicative of the existing or current organization and behavior of the webpage may be stored and accessed in 408. In certain embodiments, a Document Object Model (DOM) tree for the webpage identified in 304 may be generated based upon the HTML code of the webpage. The DOM tree for the webpage provides an object-oriented representation of the webpage contents, their organization, and their behavior. The DOM tree for the webpage is generally constructed as a tree of nodes with the nodes representing various different aspects (e.g., content, attributes, behavior) of the webpage. The nodes in the DOM tree have a hierarchical relationship to each other representing the nested nature of the elements of the webpage. Accordingly, the DOM tree for the webpage may be used in 408 to determine the existing organization and behavior of the webpage.

In one embodiment, the DOM tree for the webpage identified in 304 may be constructed as part of the processing performed upon receiving a webpage request for the webpage. In an alternative embodiment, in order to reduce the overall processing time in responding to a webpage request, the DOM-related processing may be performed independent of the webpage request processing and information related to the DOM stored in data store 114 as DOM information 218, as depicted in FIG. 2. The stored DOM information 218 may then be accessed and used for the processing performed in 408.

At 410, based upon the usage patterns determined in 406 and the current organization and behavior determined in 408 for the webpage, a determination is made as to the modifications, if any, to be made to the webpage determined in 304. In one embodiment, the usage patterns may be compared with the current organization and behavior to find any discrepancies and the discrepancies may then be used to identify the modifications to be made. Table A below provides some examples of modifications that may be identified based upon a particular existing state of the webpage and the identified usage patterns.

TABLE A

| | Current State of Webpage | Usage Pattern | Modification |
|---|---|---|---|
| 1. | Webpage comprises multiple | The users in the set of users | Change the location of the second |
| | sections with a first section located | interact more with the second | section such that the second section is |
| | in a first location on the webpage | section than the first section. | placed above the first section, and |
| | and a second section located below | | closer to the top of the webpage, on |
| | the first section on the webpage. | | the modified webpage. |
| 2. | Webpage comprises a table that is | The users in the set of users | Change the sort criterion for the table |
| | sorted according to a first criterion | more frequently sort the table | from the first criterion to the second |
| | when the webpage is displayed. | using a second criterion that is | criterion in the modified webpage such |
| | | different from the first criterion. | that when the modified webpage is |
| | | | displayed the table contents are sorted |
| | | | according to the second criterion |
| | | | instead of the first criterion. |
| 3. | Webpage comprises a drop-down | The users in the set of users | Change the ordering of the menu items |
| | menu with menu items arranged | more frequently select a | such that, when the webpage is |
| | and displayed according to a first | particular item from among the | displayed, items more frequently |
| | order. | menu items. | selected by the set of users are placed |
| | | | closer to the top of the drop-down |
| | | | menu list. |
| 4. | Webpage comprises a form field | The users in the set of users | When the webpage is displayed, the |
| | that is left blank when the webpage | enter a particular value in the | form field is shown as pre-filled with |
| | is displayed. | form field. | the particular value. |
| 5. | Webpage comprises a form field | The users in the set of users | When the webpage is displayed, the |
| | that is pre-populated with a first | more frequently select a second | form field is already pre-populated |
| | option from a list of options | option for entry in the form | with the second option instead of the |
| | associated with the form field. | field, where the second option | first option. |
| | | is different from the first | |
| | | option. | |

It is to be noted that the various examples described in Table A are only meant to be illustrative in nature and are not intended to limit the scope of the claimed embodiments. Various other use cases are possible.

Referring back to FIG. 4, at 412 a determination is made whether the processing in 410 has identified any modifications to be made to the webpage. If any modifications are to be made, then processing continues with 314 in FIG. 3, else if no modifications are to be made then processing continues with 312 in FIG. 3.

In certain embodiments, the modifications determined in 410 may be provided as intuitive suggestions to enhance the end user experience. A further determination may then be made as to which of the suggested modifications are to be actually implemented. Accordingly, in such an embodiment, a determination may be made in 314 in FIG. 3 regarding which of the suggested modifications are to be selected and actually made to the webpage. Only those selected modifications are then made to the webpage in 314 and the modified webpage then communicated to a requesting user.

As described above, various different modifications may be made to a webpage based upon usage patterns for the webpage. In certain embodiments, the modifications can be categorized as behavioral adaptations/modifications or organizational adaptations/modifications. For example, when a digital document such as a webpage is represented by a model representation such as a DOM representation, when a modification is made that changes the position of a component within the DOM tree, then the modification may be referred to as an organizational adaption or modification. When the modification involves changing the behavior of a component within the DOM tree without having to change the position of the component, then the modification is referred to as a behavioral modification. Behavioral modifications can include, for example, changes made to the behavior of a webpage or web application including without limitation changes to the default behavior of a webpage, changes to the manner in which a list of items is ordered or filtered, and the like. Organizational adaptations/modifications can include, for example, changes to the manner in which content is organized or placed on a webpage. In certain embodiments, organizational changes do not add new content but rather change the organization or placement of existing content on a webpage or in a web application. Some examples are provided below.

(1) Changing the Ordering of a List of Items on a Webpage (Behavioral Modification Example)—

There are various instances in which a webpage comprises a list of items. Examples of lists of items can include without limitation a table comprising a list of items (rows), a drop-down menu comprising a list of user-selectable items, a selection list of multiple items associated with a form-fill field, and the like. The list of items may be arranged and displayed by a webpage according to a certain order. This order may be changed responsive to usage patterns.

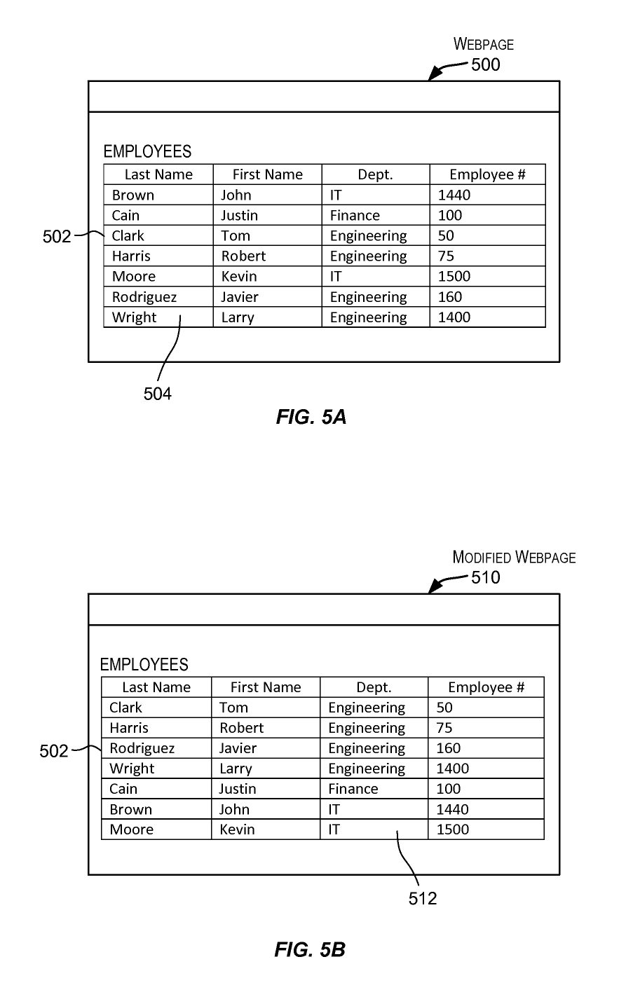

(a) Drop-down menu (or any menu in general) list example—A webpage may provide a drop-down menu comprising a list of user-selectable items. The list may be ordered according to some pre-set order. The usage pattern for the drop-down menu may indicate that the value placed in the 10^{th} position in the drop-down ordered list is more frequently selected by the users than other values. In response, adaptation engine 112 may modify the ordering of the drop-down list and create a modified ordered list in which the value that was previously in the tenth position is now placed at the top or in the first position in the drop-down menu in the modified webpage thereby making it easier for a user to select the frequently selected value.
(b) Options list example—A webpage may include an input location (e.g., a form field for receiving user input) that is associated with a list of user-selectable items. The list may be ordered according to some pre-set order. The usage pattern for the drop-down menu may indicate that a particular item is more frequently selected by a user from a set of users than the other items. In response, adaptation engine 112 may modify the ordering of the options list and create a modified ordered list such that more frequently selected items are placed at or towards the top of the options list making it easier for the user to select those items.
(c) Table example: A webpage may include a table comprising multiple columns and rows (items in table). The table may, by default, be ordered or sorted according to a particular column, i.e., a first criterion. The usage pattern for the webpage may indicate that the set of users of the webpage more frequently sort the table using a second criterion that is different from the first criterion (i.e., a different column). The default ordering or sorting criterion for the table may be dynamically changed from the first criterion to the second criterion. For example, FIG. 5A depicts a webpage 500 that includes an “EMPLOYEES” section comprising a table 502 comprising multiple rows (list of items) and columns “Last Name,” “First Name,” Dept.,” and “Employees #.” As shown in FIG. 5A, according to the default behavior, when displayed on webpage 500, the table is ordered or sorted using the “Last Name” criterion. The usage pattern for webpage 500 may however indicate that users of webpage 500 tend to more frequently order or sort table 502 using “Dept.” criterion. In response, adaptation engine 112 may automatically and dynamically create a modified webpage 510, as depicted in FIG. 5B, in which table 502 is ordered or sorted using “Dept.” as the sorting criterion. Modified webpage 510 may then be served to a user instead of webpage 500. While this example is related to ordering or sorting of items in a table, the teachings may also be applied to other actions that may be performed on a table, such as filtering of items in the table, and the like.

(2) Selecting a Value for a User-Selectable or User-Input Option (Behavioral Modification Example)—

A webpage may comprise various different types of elements where a user is allowed to select a value for the element or input a value in the element. Based upon past usage patterns for a set of users, a specific selection or input value may be determined and the webpage modified to include this determined selection or input for the element. The modified webpage is then provided to the user.

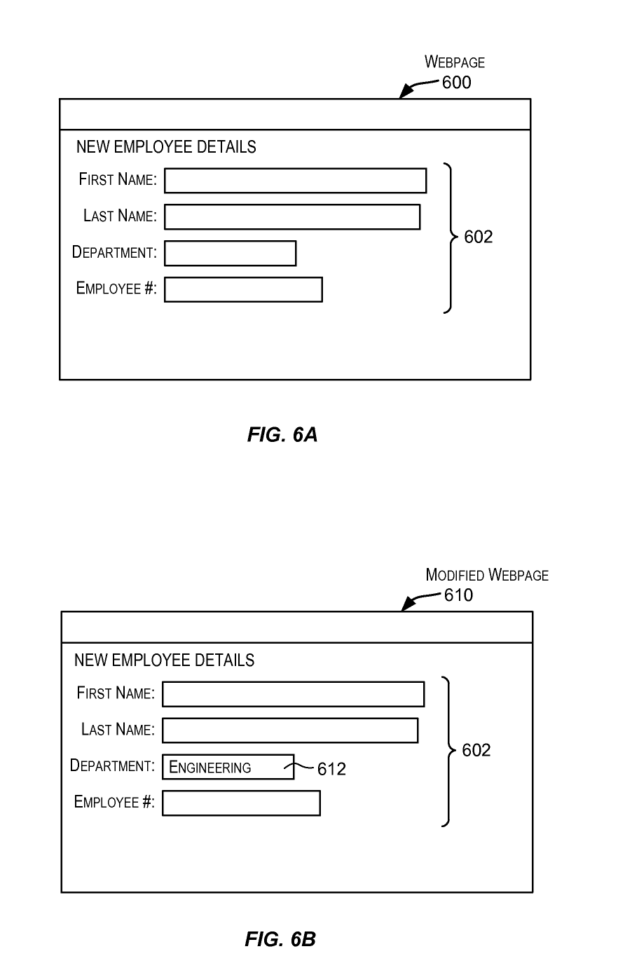

(a) Form-fill values example—A webpage may include one or more form fields, each field allowing a user to enter a value in the field. The default webpage behavior for a form field may be to leave it blank or fill it with a default value. The usage pattern for a webpage may indicate that users in a set of users are more likely to enter a particular value in the form field, which is different from the default value. Based upon this usage pattern, a modified webpage may be generated in which the particular value is pre-filled into the form field. In this manner, the value filled in the field is changed from one value (which may be a blank value or a default value) to another value responsive to prior interactions made by the set of users. For example, FIG. 6A depicts a webpage 600 comprising a section 602 including several form fields for entering new employee details. The form fields include fields for entering a first name, last name, department to which the employee belongs, and an employee identification number. The usage pattern for webpage 600 may indicate that “Engineering” is the most commonly entered value for “Department” by a set of users. In response, adaptation engine 112 may automatically and dynamically create a modified webpage 610 in which form field 612 corresponding to “Department” is pre-populated with value “Engineering” and the modified webpage then served to a user requesting webpage 600. The value prefilled in the form field may change over time as usage patterns change.
(b) Default tab—A webpage or a web application may comprise a series of tabs and the webpage or application, when displayed to users, may default to a particular tab, typically the first tab from the series of tabs, i.e., the first tab is selected and contents on the first tab displayed when the webpage is output to a user. Usage patterns may however indicate that the users in a set of users are more likely to select the third tab in the series rather than the default first tab. In such a case, in the dynamically generated modified webpage, the default tab may be changed from the first tab to a different tab and that different tab may be displayed as selected when the webpage is displayed to a user.

(3) Intuitive Navigational Suggestions (Behavioral Modification Example)—

According to certain embodiments of the present invention, a web application can be configured to predict the next navigational step of a user based upon how other users have navigated in the past. This could be very useful, for example, in a setup-related process where a usage pattern can be detected on the way users do the setup steps. For example, all customer application implementations involve a stage of setting up the application. However, this setup may be done differently by customers in different businesses or domains or industries. For a particular application being setup for a particular industry, it may be observed that a first setup step is done first using a first user interface SETUP_UI_{—}1 and is followed by a setup step using a second user interface SETUP_UI_{—}2. The rule evaluation engine of the adaptive webpages system can determine this industry-specific usage pattern and upon detecting that a customer is from the particular industry suggest the navigation to SETUP_UI_{—}2 once the setup using SETUP_UI_{—}1 is completed. In this manner, the adaptive webpages system is capable of predicting future setup flow and making corresponding modifications to the navigation within an application. It is to be understood that the setup scenario described above is an example of navigational modifications that can be made and is not meant to be restrictive. In general, modifications can be made to any type of navigation within an application.

(4) Auto-Templating and Suggesting Templates of a Page (Behavioral Modification Example)—

Based upon the pattern of usage determined for a particular webpage, the adaptive webpages system 102 can cause a web application to auto-template the webpage. Auto-templating is the process by which the adaptive webpages system makes decisions regarding the default values to be entered in the fields of a webpage and causing the web application to serve the auto-templated webpage to the user. This reduces the time taken by a user to fill-in the webpage. Suggesting such templates to a new user, makes it very easy for the user to complete the information requested on the page.

(5) Dynamic Change in Placement of Portions/Regions of a Webpage (Organizational Modification Example)—

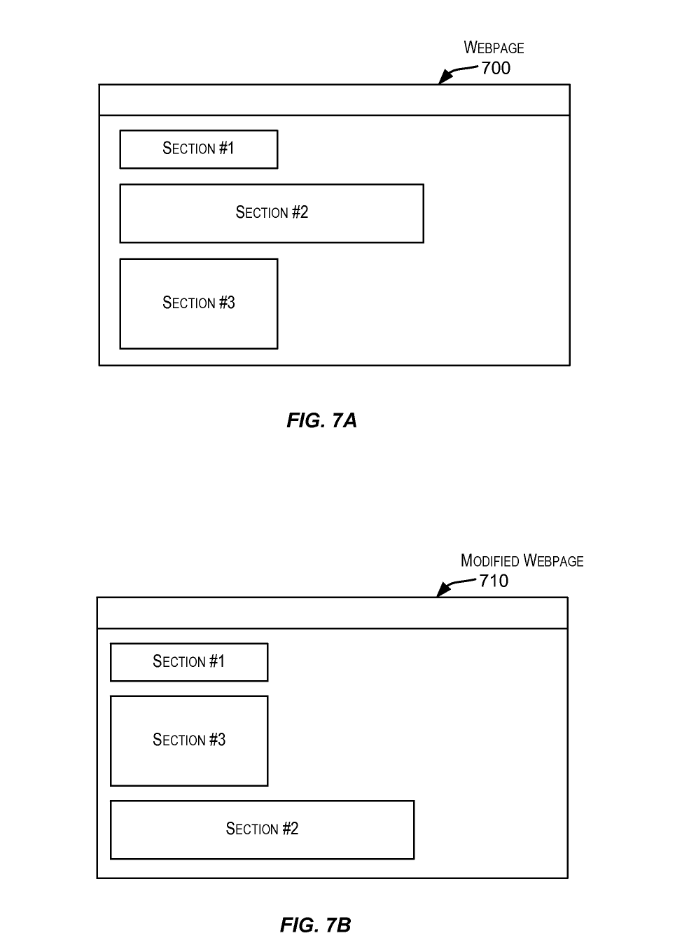

A webpage may comprise multiple different sections or regions. Depending upon the usage pattern associated with the webpage with the different sections, the placement of the sections may be changed in response. For example, a webpage may comprise multiple sections including a first section and a second section placed below the first section on the webpage. If the collected user interactions information indicates that users are more likely to interact with the second section of the webpage rather than the first section even though the first section is placed closer to the top of the webpage than the second section, then a modified webpage may be created where the relative placement of the sections is changed resulting in the second section being placed closer to the top of the webpage and above the first section. For example, FIG. 7A depicts a webpage 700 comprising three different sections, namely, Section #1, Section #2, and Section #3. For example, the sections may correspond to paragraphs or grouping of lines in the webpage. The usage pattern for webpage 700 for a set of users may indicate that users more frequently interact with Section #3 of webpage 700 than Section #2 of the webpage. In response, adaptation engine 112 may automatically and dynamically create a modified webpage 710 depicted in FIG. 7B in which Section #3 is placed above Section #2 and serve modified webpage 710 to a user requesting webpage 700. In some scenarios, if the usage pattern for the set of users indicates that Section #3 is accessed more frequently than Section #1, then Section #3 may even be placed at the top of the modified webpage (not shown in the figures) above the other sections.

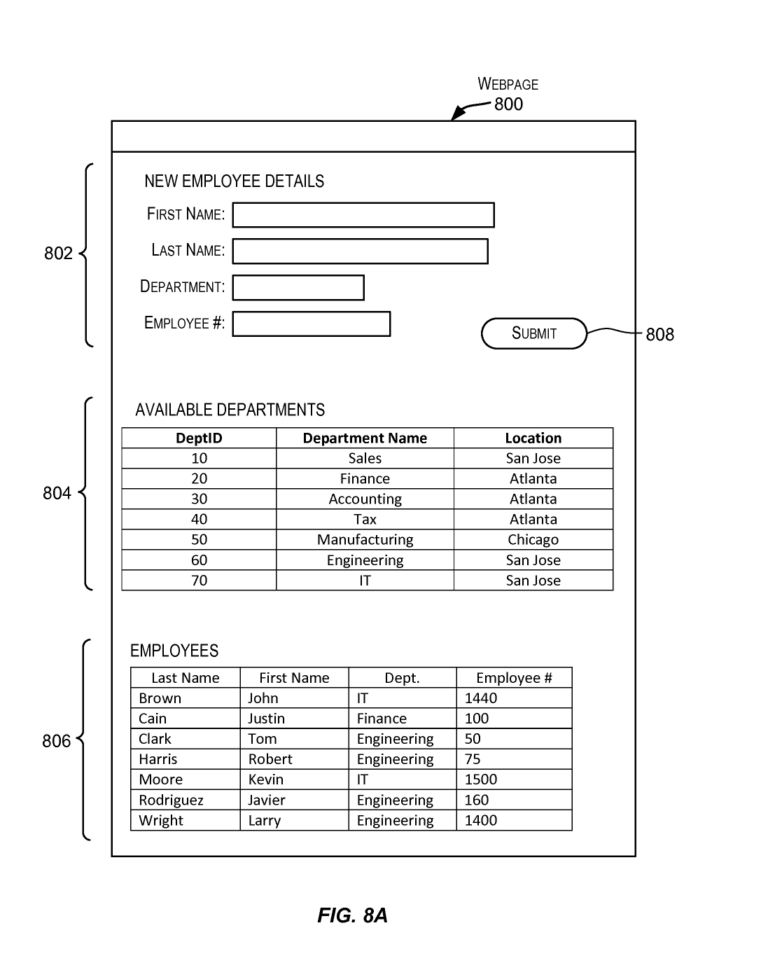

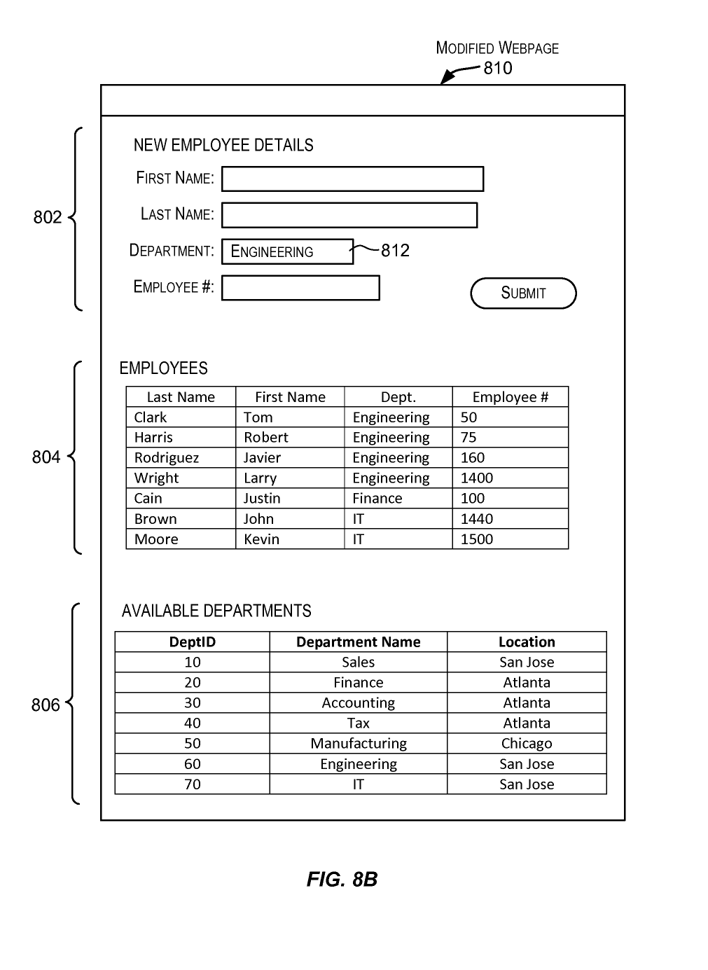

FIGS. 8A and 8B provide a use-case example depicting the manner in which usage patterns may be used to dynamically modify a webpage according to an embodiment of the present invention. FIG. 8A shows a webpage 800 prior to modifications. As shown, webpage 800 comprises three sections or regions 802, 804, and 806, namely, a “New Employee Details” section 802 for entering information for a new employee, an “Available Departments” section 804 listing all the departments that are listed in the system, and an “Employees” section 806 showing a listing of existing employees.

A user (User_{—}1) upon accessing webpage 800 may take the following actions:

(1) User_{—}1 scrolls down to check information on existing employees in section 806.
(2) The table in section 806 is by default sorted according to last name (first column of the table). User_{—}1 changes the sort criterion to “Dept.” and sorts the table using the changed criterion.
(3) User_{—}1 then enters information for a new employee in section 802. As part of entering the information, User_{—}1 enters “Engineering” as the department for the new employee. After the information has been entered, User_{—}1 then hits “Submit” button 808 to create a new employee record based upon the information entered in section 802.

User_{—}1's interactions with webpage 800 are monitored and information related to the interactions communicated to adaptation engine 112 per the techniques described above. This information may then be stored by adaptation engine 112 for further analysis. Over time, adaptation engine 112 may also receive user interactions information related to multiple users' interactions with webpage 800. Once sufficient information has been gathered for modifications-related analysis, adaptation engine 112 may then determine and make modifications to webpage 800 for subsequent requests for webpage 800.

The threshold or amount of information that is considered sufficient for adaptation engine 112 to start recommending and making modifications to webpage 800 is configurable. For example, in some scenarios, user interactions information for even a single instance (e.g., interaction by User_{—}1) may be sufficient to enable adaptation engine 112 to determine and make modifications to webpage 800 for subsequent requests for that webpage. In another scenario, user interactions information may be gathered for a configurable threshold number of usage instances before modifications are made.

Assuming that adaptation engine 112 has gathered sufficient usage information for webpage 800 (assume that information collected for User_{—}1 is sufficient), a subsequent request for webpage 800 triggers the modifications-related analysis. For example, adaptation engine 112 may receive a webpage request for webpage 800 from a new user (User_New). This may be the first time that User_New has requested webpage 800. In response, adaptation engine 112 may, based upon previously received user interactions information 118, determine the following usage patterns:

(Usage Pattern #1) There is more interaction with section 806 than with section 804.
(Usage Pattern #2) The table (or any object in general) in section 804 is sorted using “Dept.” as the sorting criterion instead of the default.
(Usage Pattern #3) When new employee information is entered in section 802, the value “Engineering” is entered for the department field.

Based upon the above-determined usage patterns, adaptation engine 112 may identify and make the following modifications to webpage 800 in response to a new webpage request for webpage 800:

(Modification #1: Corresponding to Usage Pattern #1)—Change the position of section 806 relative to section 804 such that section 806 appears closer to the top of the webpage and above section 804.
(Modification #2: Corresponding to Usage Pattern #2)—Change the criterion for sorting the table in section 804 to “Dept.” instead of “Last Name” such that when the webpage is displayed the items in the table in section 804 are sorted by “Dept.”
(Modification #3: Corresponding to Usage Pattern #3)—Pre-fill the “DEPARTMENT” form field for receiving input regarding department information for a new employee with the value “Engineering”.

Adaptation engine 112 may then build a modified webpage incorporating the above modifications. An example of such a modified webpage 810 is depicted in FIG. 8B. Modified webpage 810 may then be sent as a response to the webpage request received from User_New. In this manner, modified webpage 810, instead of webpage 800 is sent to User_New. User_New may or may not (i.e., may be requesting webpage 800 for the first time) have previously requested or interacted with webpage 800, but still gets the modified webpage based upon usage patterns of other users. User_New thus gets the benefit of previous webpage interactions of other users. Accordingly, there is no need for a user to have previously requested or interacted with a webpage to get a modified version of the webpage.

Further, the modifications are not restricted to a specific user session. The modifications are provided across user sessions and can be made based upon interactions of different users across different sessions. For example, a first user's interactions with a webpage during a first session may be used to modify the same webpage when requested by a second user during a different session. Likewise, the interactions of the first user and the second user may be used to further modify the webpage before the webpage is served to a third user. Accordingly, a webpage can be dynamically modified to reflect changing usage patterns for a set of users. A webpage could thus go through a series of different modifications for a set of users as the users' usage patterns change. An adaptive webpages system is capable of performing such modifications for different sets of users. In this manner, the adaptive webpages system provides a way for the same webpage (or any digital document in general) to be automatically and dynamically modified in a customized manner for different sets of users. The same webpage may possibly be modified in different ways for different sets of users.

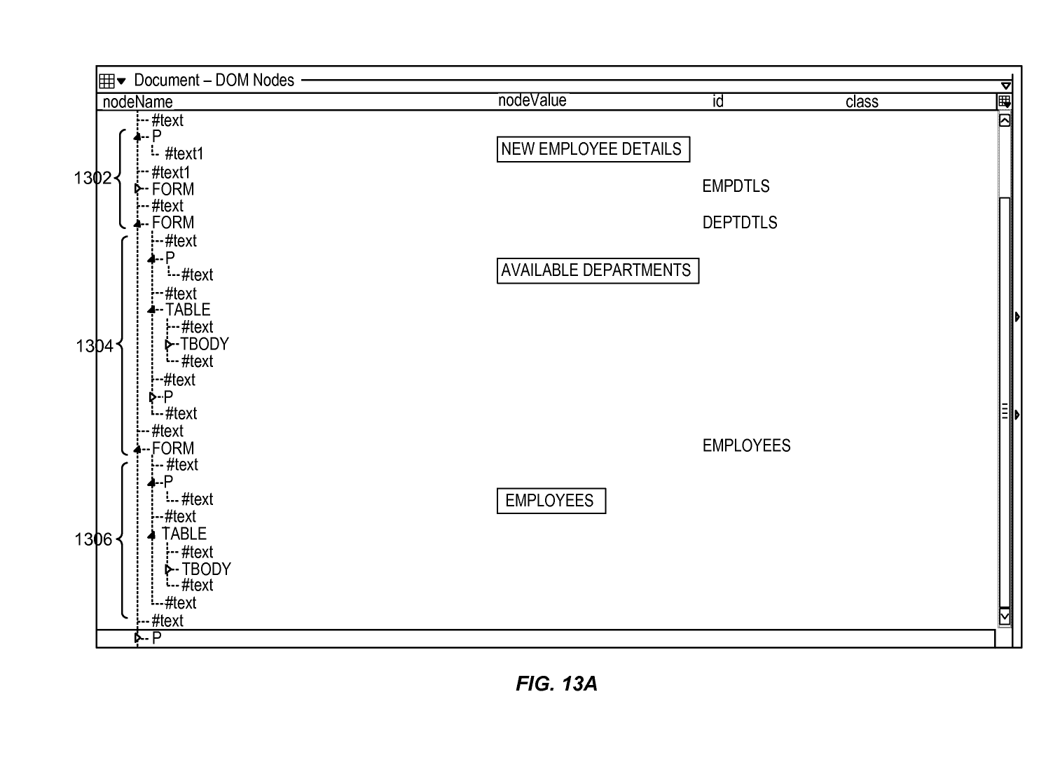

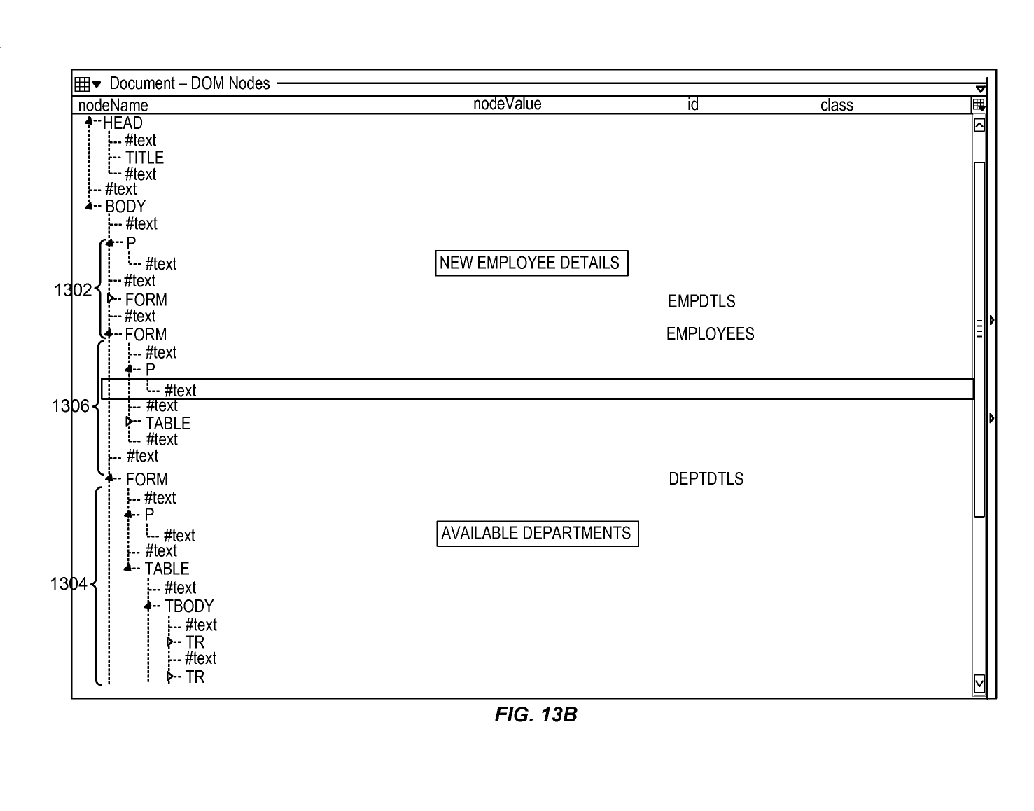

As described above, in certain embodiments, the DOM for a webpage may be used for determining the structure and behavior of a webpage and for facilitating modifications to the webpage. FIG. 13A depicts a portion of a DOM tree corresponding to webpage 800 depicted in FIG. 8A according to an embodiment of the present invention. The portion shown in FIG. 13A identifies various nodes (identified by “nodeName”) of the DOM tree and the hierarchical relationships between the nodes. The node values for some of the nodes are also shown. For example, tree portion 1302 identifies nodes corresponding to components in section 802 of webpage 800 including a node for the form-fields. Different form fields in a section may be referred to as child nodes of the parent section node. Tree portion 1304 identifies nodes corresponding to components in section 804 of webpage 800. Tree portion 1306 identifies nodes corresponding to components in section 806 of webpage 800 in FIG. 8A.

FIG. 13B depicts a portion of a modified DOM tree corresponding to modified webpage 810 depicted in FIG. 8B according to an embodiment of the present invention. In one embodiment, the modifications to the DOM tree may be determined by rules evaluation engine 212 in FIG. 2 and the modifications made by webpage modifier 214. As shown in FIG. 13B, the positions of some of the nodes in the DOM tree have been changed to reflect the modifications. For example, the nodes (tree section 1306) corresponding to the components in section 806 of the webpage now appear in the tree before the nodes (tree portion 1304) corresponding to the components in section 804 of the webpage, which causes section 806 to be placed above section 804 in modified webpage 810. Changes can be made to the DOM tree to change the criterion for sorting the table in section 804 from “Last Name” to “Dept.” and to prefill “Engineering” in the form field corresponding to “Department” instead of “Last Name.” In the DOM depicted in FIG. 13B, these strings are hidden under ‘#text’ and the corresponding values can be viewed using a tool such as a DOM inspector tool. In section 1302 in FIG. 13B, one of the ‘#text’ values would be “Engineering”. The sorting of the related nodes can be observed by expanding corresponding ‘TABLE’ node for section 1306 in FIG. 13B (this node is not expanded for 1306 in FIG. 13B but this expansion would look akin to the expanded node for section 1304 in FIG. 13B.

In certain embodiments, as described above, adaptation engine 112 is able to differentiate between sets of users. For example, adaptation engine 112 may receive user interactions information for different sets of users. The usage patterns determined from the user interactions information may be different for different sets of users. Accordingly, the modifications made to the webpage may also be different for the different sets of users. For example, in the above example, if User_{—}1 and User_New belong to a first set of users, then the usage patterns for this first set of users may be different from the usage patterns for the same webpage 800 for a different second set of users. Accordingly, the modifications made to webpage 800 for the first set of users can be different from the modifications made to the same webpage for the second set of users.

In certain embodiments, a webpage can evolve through multiple modified versions responsive to changes in usage patterns. For example, a web application may start out providing a “base” version of a webpage. Based upon interactions with the base version and usage patterns derived from these interactions, one or more modifications may be made to the “base” version and a “1^{st} modified” version of the webpage created and served to users instead of the “base” version. Over time, user interactions information may be collected for interactions with the 1^{st} modified version and new usage patterns determined from the collected information. These new usage patterns may result in a “2^{nd} modified” version of the webpage being created and served to users instead of the “1^{st} modified” version. User interactions information may then be collected for the 2^{nd} modified version, usage patterns determined from the information, and further modifications made to the webpage. In this manner, modifications can be dynamically made to a webpage responsive to changes in user usage patterns.

The way in which a webpage is requested by the end user does not change even though modified versions of the webpage may be served to the user. A webpage request that results in the “base” version of the webpage being sent in response is the same as a webpage request that results in the “1^{st} modified” version or the “2^{nd} modified” version of the webpage being sent as a response. The user thus does not have to change his/her behavior in requesting the webpage. The analysis and processing for determining the modifications to be made and the webpage to be sent to the user is made by adaptation engine 112, without any additional input or interaction from the user, other than the webpage request itself.

Embodiments of the present invention are very flexible in the modifications that can be made to a digital document such as a webpage. The specific modifications do not have to be pre-identified to a designer of the webpage. Additionally, the webpage designer does not have to reserve or earmark certain components or sections of a webpage for modifications.

In the embodiment depicted in FIGS. 1 and 2, web server 110 and adaptation engine 112 are co-located, with adaptation engine 112 having direct access to webpages served to the clients. FIG. 9 depicts another embodiment that may incorporate teachings of the present invention. Common components in FIGS. 1 and 9 are referenced using the same reference numbers. In the embodiment depicted in FIG. 9, the website functionality and the adaptation engine functionality are separated from each other on separate systems. A website system 902 hosts a website and is configured to serve webpages to clients in response to webpage requests received from the clients. Website system 902 may comprise a web server 110 that is configured to receive webpage requests from one or more clients and respond by communicating the corresponding webpages to the requesting clients. The webpages 116 may be stored in a location accessible to web server 110.

In the embodiment depicted in FIG. 9, processing and analysis services related to webpage usage analysis and webpage modifications are provided by adaptation service provider system 906. The services may be provided to one or more website or web application vendors such as website system 902. In one embodiment, the services offered by adaptation service provider system 906 may be offered as cloud services, for example, may be provided according to a Software as a Service (SaaS) model.

In the embodiment depicted in FIG. 9, adaptation service provider system 906 comprises an adaptation engine 112 and a data store 908 that may store information related to services provided by adaptation service provider system 906. For example, the stored information may include user interactions information 118, adaptation rules 120, usage patterns information, and the like.

In certain embodiments, at (1), user webpage interactions may be monitored at the clients and user interactions information communicated to adaptation service provider system 906. The information may be stored in data store 908. The monitoring, collection, and storage of user interactions information 118 may be performed asynchronously from the processing related to webpage requests.

At (2), a webpage request may be communicated from a client to website system 902. At (3), website system 902 may determine a webpage to be sent back to the client in response to the received webpage request. However, instead of sending the webpage to the client, website system 902 may use the services provided by adaptation service provider system 906 to determine if the webpage is to be modified before it is sent to the client. Accordingly, in one embodiment, at (4), website system 902 may communicate the identified webpage to adaptation service provider system 906. As part of (4), website system 902 may also send information to adaptation service provider system 906 that enables adaptation service provider system 906 to determine the set of users for the analysis.

At (5), adaptation service provider system 906 performs processing to determine the modifications, if any, to be made to the webpage received from website system 902. For example, in one embodiment, adaptation service provider system 906 may perform processing corresponding to 306, 308, 310, 314 in FIG. 3 and processing corresponding to flowchart 400 depicted in FIG. 4.

At (6), adaptation service provider system 906 may communicate the modified webpage to website system 902. At (7), website system 902 may then communicate the modified webpage received from adaptation service provider system 906 to the client in response to the received webpage request. If the webpage is not modified, then at (6), adaptation service provider system 906 may send a signal to website system 902 that there are no modifications for the webpage (or may send the unmodified webpage to website system 902), and then at (7), website system 902 may communicate the unmodified webpage to the requesting client.

As depicted in FIG. 9 and described above, adaptation service provider system 906 may offer the processing and analysis services related to webpage usage analysis and webpage modifications as a service to one or more third party service requesters. In one embodiment, the services may be offered as cloud services according to a SaaS model.

As described above, embodiments of the present invention enable modifications to be made to webpages in an automated and dynamic manner and responsive to user usage patterns and without having to go through multiple iterations of redesigning the webpages. A web application serving webpages can thus be dynamically adapted in a manner that conforms with and is responsive to the end users' intended use of the application. This significantly reduces the time, cost, and effort needed for delivering applications to users with potentially differing usage patterns.

For example, consider an application or product that is being provided to various different customers by an application vendor. For example, the application could be one that is provided by Oracle Corporation to various different customers, who use the product differently. An example could be a Human Resources (HR) application with one or more webpages for “New Hire” flow information. An Information Technology (IT) company may use this application and these webpages quite differently from a Supply Chain Company. For example, the IT company may choose to enter more profile information than the Supply Chain company. Accordingly, regions of the webpages related to entering profile information are bound to be more frequently used by the IT company than the Supply Chain company. Certain embodiments of the present invention enable these webpages to be modified for the IT company without affecting the webpages provided to the Supply Chain company such that the sections of the webpage for entering profile information are more readily accessible to the IT company on the webpage. This may be done, for example, by changing the locations of the sections such that they are closer to the top of the webpage and are thus easily accessible without having to do any scrolling of the webpage. In this manner, a single product can cater to different customers with different requirements without any additional design or coding efforts on part of the application provider. The application automatically itself learns from usage patterns and dynamically makes modifications to suit particular end users. The ability to automate the dynamic generation of modified webpages (or digital documents in general) responsive to user interactions for different sets of users enables a common product to be offered to multiple sets of users even though the different sets of users may use the product differently.

By providing customized modified webpages, embodiments of the present invention make the web application easier to use by differently-abled users. Enhanced accessibility support is provided for differently-abled persons using a web application. The information that is most likely consumed by the user can be delivered to the users with minimum interactions with the users. For example, be it the defaulting behavior, intuitive navigational suggestions or behavioral adaptations made to an application, the modifications are based usage patterns derived from prior user interactions with the webpage. The modifications aim to predict what a prospective user may want to see in the structure and/or behavior of the webpage without the prospective user having to explicitly do anything (e.g., explicitly set user preferences). The prospective user thus gains the benefit of interactions of other users in the set of users to which the prospective user belongs. This minimizes the effort involved in interacting with the application, since at each stage, the application predicts user behavior, including the manner in which the user prefers to consume information, and adapts the presented content accordingly. While several examples of modifications have been described above, these are not intended limits the modifications that can be made by embodiments of the present invention. A modified webpage may comprise one or more of these modifications including combinations of the modifications. For example, a modified webpage may have multiple modifications such as the location of a section within the webpage may be changed in the modified webpage and also the ordering of a list of elements in the webpage may be changed.

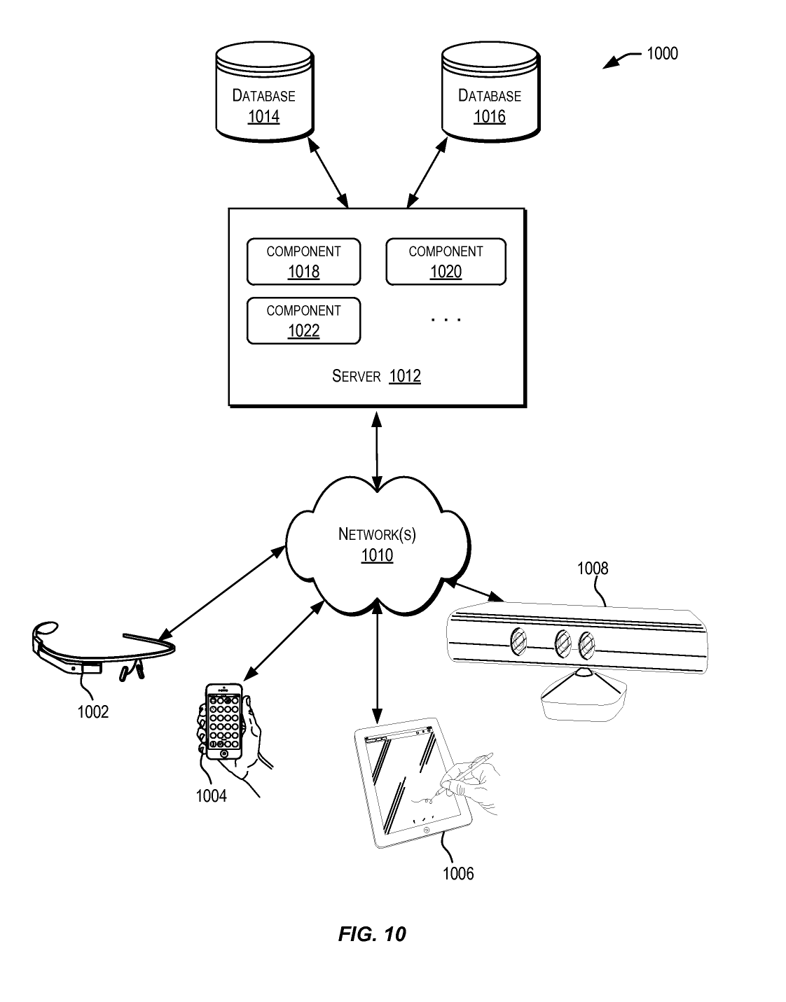

FIG. 10 depicts a simplified diagram of a distributed system 1000 for implementing an embodiment. In the illustrated embodiment, distributed system 1000 includes one or more client computing devices 1002, 1004, 1006, and 1008, which are configured to execute and operate client applications such as a web browser, proprietary client (e.g., Oracle Forms), or the like over one or more network(s) 1010. Server 1012 may be communicatively coupled with remote client computing devices 1002, 1004, 1006, and 1008 via network 1010.

In various embodiments, server 1012 may be adapted to run one or more services or software applications such as services and applications that provide the digital document (e.g., webpage) analysis and modification-related processing described above. In certain embodiments, server 1012 may also provide other services or software applications that can include non-virtual and virtual environments. In some embodiments, these services may be offered as web-based or cloud services, such as under a Software as a Service (SaaS) model to the users of client computing devices 1002, 1004, 1006, and/or 1008. Users operating client computing devices 1002, 1004, 1006, and/or 1008 may in turn utilize one or more client applications to interact with server 1012 to utilize the services provided by these components.

In the configuration depicted in FIG. 10, server 1012 may provide the functionality provided by adaptive webpages system 102. The functionality may be provided by software components 1018, 1020 and 1022 implemented on server 1012. In certain embodiments, client computing devices 1002, 1004, 1006, and/or 1008 may also implement one or more components that facilitate the interactions analysis and digital document modification functionality. Users operating the client computing devices may then utilize one or more client applications to use the services provided by these components. These components may be implemented in hardware, firmware, software, or combinations thereof. It should be appreciated that various different system configurations are possible, which may be different from distributed system 1000. The embodiment shown in FIG. 10 is thus one example of a distributed system for implementing an embodiment system and is not intended to be limiting.

Users may use client computing devices 1002, 1004, 1006, and/or 1008 to request digital documents (e.g., to request webpages). The documents received by a client in response to the document request may then be output to the user of the device via an interface of the client device. Although FIG. 10 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone, Android™, BlackBerry® 10, Palm OS). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device), and the like. The client devices may be capable of executing various different applications such as various Internet-related apps, communication applications (e.g., E-mail applications, short message service (SMS) applications) and may use various communication protocols.

Network(s) 1010 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, network(s) 1010 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1012 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1012 can include one or more virtual machines running virtual operating systems, or other computing architectures involving virtualization such as one or more flexible pools of logical storage devices that can be virtualized to maintain virtual storage devices for the server. In various embodiments, server 1012 may be adapted to run one or more services or software applications that provide the functionality described in the foregoing disclosure.

The computing systems in server 1012 may run one or more operating systems including any of those discussed above, as well as any commercially available server operating system. Server 1012 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 1012 may include one or more applications to analyze and consolidate data feeds and/or event updates received from users of client computing devices 1002, 1004, 1006, and 1008. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1012 may also include one or more applications to display the data feeds and/or real-time events via one or more display devices of client computing devices 1002, 1004, 1006, and 1008.

Distributed system 1000 may also include one or more data repositories such as databases 1014 and 1016. These databases may provide a mechanism for storing information such as user interactions information, usage patterns information, adaptation rules information, and other information used by embodiments of the present invention. Databases 1014 and 1016 may reside in a variety of locations. By way of example, one or more of databases 1014 and 1016 may reside on a non-transitory storage medium local to (and/or resident in) server 1012. Alternatively, databases 1014 and 1016 may be remote from server 1012 and in communication with server 1012 via a network-based or dedicated connection. In one set of embodiments, databases 1014 and 1016 may reside in a storage-area network (SAN). Similarly, any necessary files for performing the functions attributed to server 1012 may be stored locally on server 1012 and/or remotely, as appropriate. In one set of embodiments, databases 1014 and 1016 may include relational databases, such as databases provided by Oracle, that are adapted to store, update, and retrieve data in response to SQL-formatted commands.

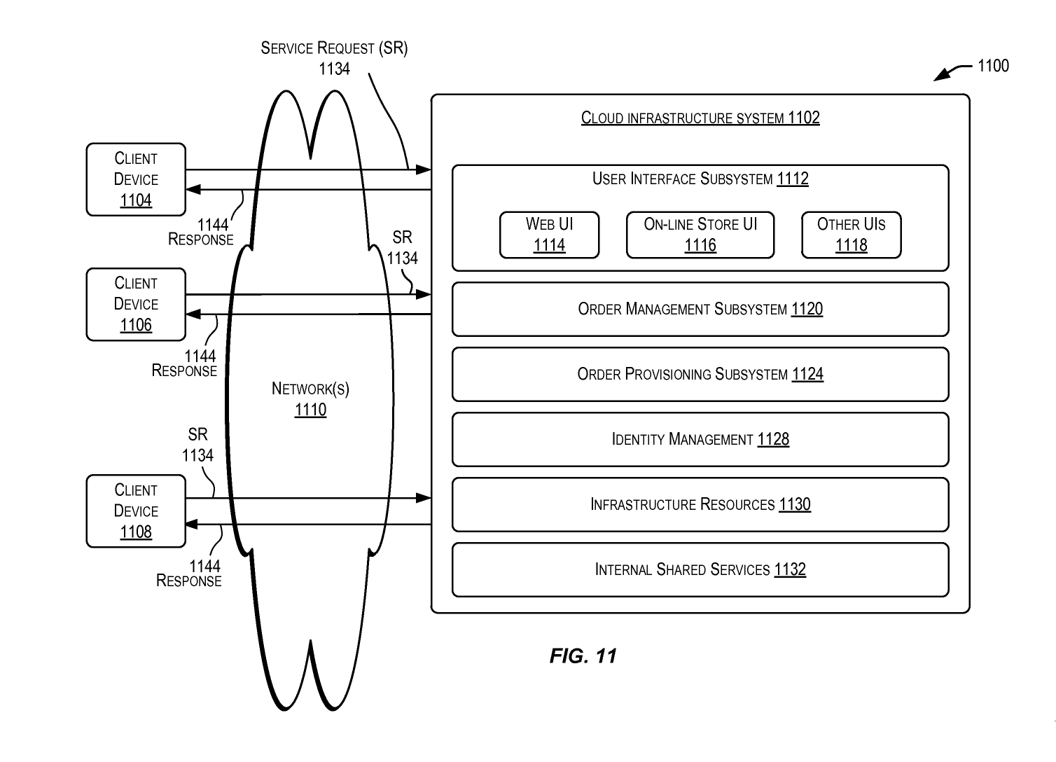

In certain embodiments, the document analysis and modification services described above may be offered as services via a cloud environment. FIG. 11 is a simplified block diagram of a cloud-based system environment 1100 in which services, such as the dynamic modification of digital documents responsive to usage patterns as described above, may be offered as cloud services, in accordance with an embodiment of the present disclosure. In the illustrated embodiment in FIG. 11, cloud infrastructure system 1102 may provide one or more cloud services that may be requested by users using one or more client computing devices 1104, 1106, and 1108. Cloud infrastructure system 1102 may comprise one or more computers and/or servers that may include those described above for server 1012. The computers in cloud infrastructure system 1102 may be organized as general purpose computers, specialized server computers, server farms, server clusters, or any other appropriate arrangement and/or combination.

Network(s) 1110 may facilitate communication and exchange of data between clients 1104, 1106, and 1108 and cloud infrastructure system 1102. Network(s) 1110 may include one or more networks. The networks may be of the same or different types. Network(s) 1110 may support one or more communication protocols, including wired and/or wireless protocols, for facilitating the communications.

The embodiment depicted in FIG. 11 is only one example of a cloud infrastructure system that may incorporate an embodiment of the invention and is not intended to be limiting. It should be appreciated that, in some other embodiments, cloud infrastructure system 1102 may have more or fewer components than those depicted in FIG. 11, may combine two or more components, or may have a different configuration or arrangement of components. For example, although FIG. 11 depicts three client computing devices, any number of client computing devices may be supported in alternative embodiments.

The term “cloud service” is generally used to refer to a service that is made available to users on demand and via a communication network such as the Internet by systems (e.g., cloud infrastructure system 1102) of a cloud service provider. Typically, in a public cloud environment, servers and systems that make up the cloud service provider's system are different from the customer's own on-premises servers and systems and are managed by the cloud service provider. This enables customers to acquire cloud services without the need for the customers to purchase separate licenses, support, or hardware and software resources for the services. For example, a cloud service provider's system may host an application, and a user may, via the Internet, on demand, order and use the application. Cloud services are designed to provide easy, scalable access to applications, resources and services. Examples of cloud services provided by Oracle Corporation® of Redwood Shores, Calif., include without limitation, middleware service, database service, Java cloud service, and others.

Cloud infrastructure system 1102 may provide one or more cloud services. These services may be provided under various models such as under a Software as a Service (SaaS) model, a Platform as a Service (PaaS) model, an Infrastructure as a Service (IaaS) model, and others including hybrid service models. For example, a SaaS model may be used to provide customers access to on-demand applications that are hosted by cloud infrastructure system 1102. SaaS thus enables an application or software to be delivered to a customer over a communication network like the Internet, as a service, without the customer having to buy the hardware or software for the underlying application. The IaaS model is generally used to provide infrastructure resources (e.g., servers, storage, hardware and networking resources) to a customer as a cloud service. The PaaS model is generally used to provide, as a service, platform and environment resources that enable customers to develop, run, and manage applications and services without the customer having to procure, build, or maintain such resources. Examples of services provided under the IaaS model include, without limitation, Oracle Java Cloud Service (JCS) and Oracle Database Cloud Service (DBCS) provided by Oracle Corporation, Redwood Shores, Calif., and others. An example of a cloud infrastructure system is the Oracle Public Cloud provided by Oracle Corporation. Cloud infrastructure system 1102 may include a suite of applications, middleware, databases, and other resources that enable provision of the various cloud services.

Cloud services are generally provided on an on demand basis self-service basis, subscription-based, elastically scalable, reliable, highly available, and secure manner. For example, a customer, via a subscription order, may order one or more services provided by cloud infrastructure system 1102. Cloud infrastructure system 1102 then performs processing to provide the services in the customer's subscription order. For example, a website provider may request cloud infrastructure system to monitor a particular set of users' interactions with webpages provided by that website and provide automated modification capability for these webpages responsive to usage patterns determined based upon the monitored information. In addition to services related to dynamic document modification responsive to usage patterns, cloud infrastructure system 1102 may be configured to provide other services.

Cloud infrastructure system 1102 may provide the cloud services via different deployment models. In a public cloud model, cloud infrastructure system 1102 may be owned by a third party services provider and the cloud services are offered to any general public customer, where the customer can be an individual or an enterprise. In other embodiments, under a private cloud model, cloud infrastructure system 1102 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other embodiments, under a community cloud model, the cloud infrastructure system 1102 and the services provided may be shared by several organizations in a related community. Various other models such as hybrids of the above mentioned models may also be used.

Client computing devices 1104, 1106, and 1108 may be devices similar to those described above for 1002, 1004, 1006, and 1008 and may be capable of operating one or more client applications such as a web browser and other applications. A user may use a client device to interact with cloud infrastructure system 1102 such as to request a service provided by cloud infrastructure system 1102 using a client device, provide adaptation rules, etc. Client devices may also be used to request digital documents and to receive modified digital documents according to the teachings of the embodiments of the present invention.

In some embodiments, the processing performed by cloud infrastructure system 1102 for providing interactions monitoring and dynamic document modification services may involve “big data” analysis. The term “big data” is generally used to refer to extremely large data sets that can be stored, analyzed, and manipulated to detect and visualize various trends, behaviors, relationships, etc. within the data. Big data analysis may involve multiple processors processing the data possibly in parallel, performing simulations using the data, and the like. For example, analysis of the collected user interactions information and deriving usage patterns from the collected data for multiple sets of users and then using the usage patterns to drive modifications of documents may involve “big data” analysis. The data that is collected and analyzed may include structured data (e.g., data stored in a database or structured according to a structured model) and/or unstructured data (e.g., data blobs (binary large objects)).

As depicted in the embodiment in FIG. 11, cloud infrastructure system 1102 may also include infrastructure resources 1130 that are utilized for facilitating the provision of cloud services by cloud infrastructure system 1102. Infrastructure resources 1130 may include, for example, processing resources, storage or memory resources, networking resources, and the like. In certain embodiments, to facilitate efficient provision of these resources for supporting the various cloud services provided by cloud infrastructure system 1102 for different customers, the resources may be bundled into resource modules (also referred to as “pods”). Each resource module or pod may comprise a pre-integrated and optimized combination of resources of one or more types. In certain embodiments, different pods may be pre-provisioned for different types of cloud services. For example, a first set of pods may be provisioned for a database service, a second set of pods, which may include a different combination of resources from the first set of pods, may be provisioned for Java service, and the like. For some services, the resources allocated for provisioning the services may be shared between the services.

Cloud infrastructure system 1102 may itself internally use services 1132 that are shared by different components of cloud infrastructure system 1102 and which facilitate the provision of services by cloud infrastructure system 1102. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 1102 may comprise a user interface subsystem 1112 that enables users or customers of cloud infrastructure system 1102 to interact with cloud infrastructure system 1102. User interface subsystem 1112 may include various different interfaces such as a web interface 1114, an online store interface 1116 where cloud services provided by cloud infrastructure system 1102 are advertised and are purchasable by a consumer, and other interfaces 1118. For example, a customer may, using a client device, request (service request 1134) one or more services provided by cloud infrastructure system 1102 using one or more of interfaces 1114, 1116, and 1118. For example, a customer may access the online store, browse cloud services offered by cloud infrastructure system 1102, and place a subscription order for one or more services offered by cloud infrastructure system 1102 that the customer wishes to subscribe to. The service request may include information identifying the customer and one or more services that the customer desires to subscribe to. For example, a customer may order the digital document modification service offered by cloud infrastructure system 1102.

Cloud infrastructure system 1102 may comprise various modules for handling service requests received from customers. These modules may be implemented in hardware or software or combinations thereof. In one embodiment, an order management subsystem (OMS) 1120 may be provided that is configured to process the new order. As part of this processing, OMS 1120 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Order provisioning subsystem (OPS) 1124 may be configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 1124 is configured to determine the cloud service being requested and identify a number of pods that may have been pre-configured for that cloud service. The number of pods that are allocated may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

Cloud infrastructure system 1102 may send a response or notification 1144 to the requesting customer to indicate that the requested service is now ready for use. In some instances, information (e.g. a link) may be sent to the customer that enables the customer to start using and availing the benefits of the requested services.

Cloud infrastructure system 1102 may provide services to multiple customers. For each customer, cloud infrastructure system 1102 is responsible for managing information related to one or more subscription orders from the customer, maintaining customer data related to the orders, and providing the requested services to the customer. Cloud infrastructure system 1102 may also collect usage statistics regarding a customer's use of subscribed services. For example, statistics may be collected for the amount of storage used, the amount of data transferred, the number of users, and the amount of system up time and system down time, and the like. This usage information may be used to bill the customer. In this manner, cloud infrastructure system 1102 may store information, including possibly proprietary information, for multiple customers.

In certain embodiments, cloud infrastructure system 1102 comprises an identity management subsystem (IMS) 1128 for managing customers information and providing the separation of the managed information such that information related to one customer is not accessible by another customer. IMS 1128 may be configured to provide identity services, such as information access management, authentication and authorization services, manage customer identities and roles and related capabilities, and the like.

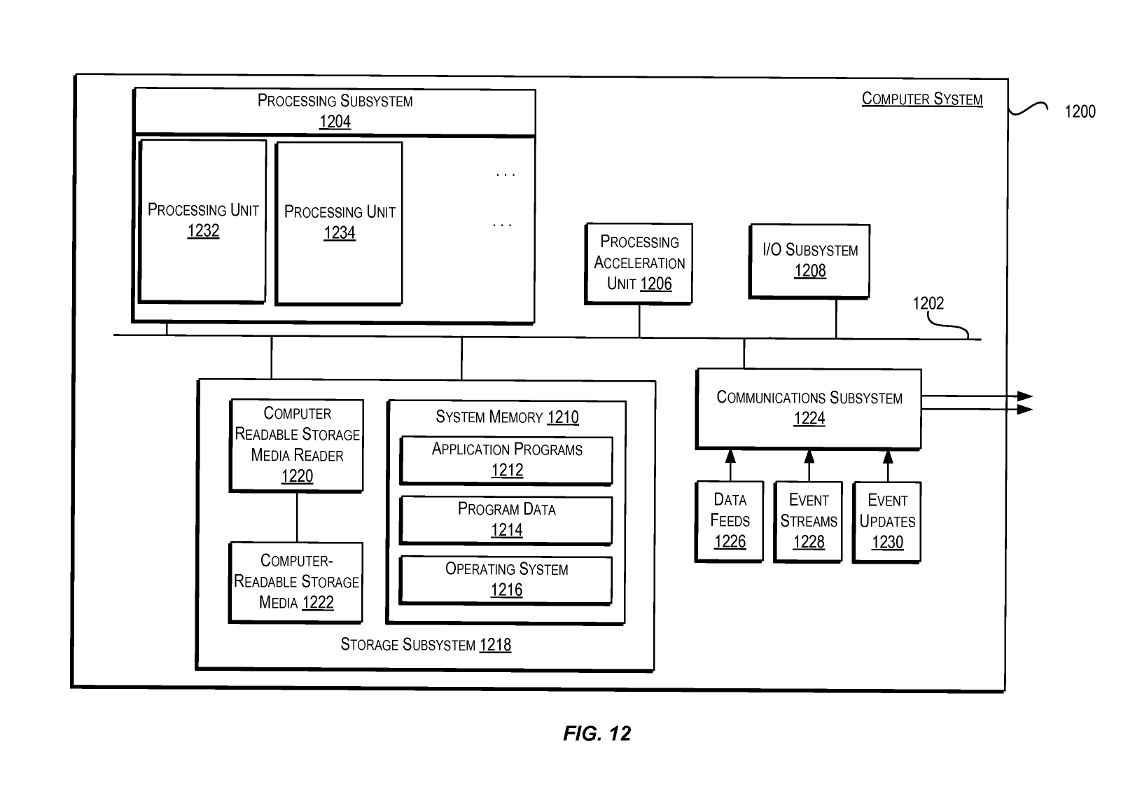

FIG. 12 illustrates an exemplary computer system 1200 that may be used to implement an embodiment of the present invention. In some embodiments, computer system 1200 may be used to implement any of the various servers and computer systems described above. As shown in FIG. 12, computer system 1200 includes various subsystems including a processing subsystem 1204 that communicates with a number of other subsystems via a bus subsystem 1202. These other subsystems may include a processing acceleration unit 1206, an I/O subsystem 1208, a storage subsystem 1218, and a communications subsystem 1224. Storage subsystem 1218 may include tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1204 controls the operation of computer system 1200 and may comprise one or more processing units 1232, 1234, etc. A processing unit may include be one or more processors, including single core or multicore processors, one or more cores of processors, or combinations thereof. In some embodiments, processing subsystem 1204 can include one or more special purpose co-processors such as graphics processors, digital signal processors (DSPs), or the like. In some embodiments, some or all of the processing units of processing subsystem 1204 can be implemented using customized circuits, such as application specific integrated circuits (ASICs), or field programmable gate arrays (FPGAs).

In some embodiments, the processing units in processing subsystem 1204 can execute instructions stored in system memory 1210 or on computer readable storage media 1222. In various embodiments, the processing units can execute a variety of programs or code instructions and can maintain multiple concurrently executing programs or processes. At any given time, some or all of the program code to be executed can be resident in system memory 1210 and/or on computer-readable storage media 1222 including potentially on one or more storage devices. Through suitable programming, processing subsystem 1204 can provide various functionalities described above for dynamically modifying documents (e.g., webpages) responsive to usage patterns.

In certain embodiments, a processing acceleration unit 1206 may be optionally provided for performing customized processing or for off-loading some of the processing performed by processing subsystem 1204 so as to accelerate the overall processing performed by computer system 1200.

I/O subsystem 1208 may include devices and mechanisms for inputting information to computer system 1200 and/or for outputting information from or via computer system 1200. In general, use of the term “input device” is intended to include all possible types of devices and mechanisms for inputting information to computer system 1200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term “output device” is intended to include all possible types of devices and mechanisms for outputting information from computer system 1200 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1218 provides a repository or data store for storing information that is used by computer system 1200. Storage subsystem 1218 provides a tangible non-transitory computer-readable storage medium for storing the basic programming and data constructs that provide the functionality of some embodiments. Software (programs, code modules, instructions) that when executed by processing subsystem 1204 provide the functionality described above may be stored in storage subsystem 1218. The software may be executed by one or more processing units of processing subsystem 1204. Storage subsystem 1218 may also provide a repository for storing data used in accordance with the present invention.

Storage subsystem 1218 may include one or more non-transitory memory devices, including volatile and non-volatile memory devices. As shown in FIG. 12, storage subsystem 1218 includes a system memory 1210 and a computer-readable storage media 1222. System memory 1210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1200, such as during start-up, may typically be stored in the ROM. The RAM typically contains data and/or program modules that are presently being operated and executed by processing subsystem 1204. In some implementations, system memory 1210 may include multiple different types of memory, such as static random access memory (SRAM) or dynamic random access memory (DRAM).

By way of example, and not limitation, as depicted in FIG. 12, system memory 1210 may store application programs 1212, which may include various applications such as Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 1222 may store programming and data constructs that provide the functionality of some embodiments. Software (programs, code modules, instructions) that, when executed by processing subsystem 1204 provides the functionality described above, may be stored in storage subsystem 1218. By way of example, computer-readable storage media 1222 may include non-volatile memory such as a hard disk drive, a magnetic disk drive, an optical disk drive such as a CD ROM, DVD, a Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 1222 may provide storage of computer-readable instructions, data structures, program modules, and other data for computer system 1200.

In certain embodiments, storage subsystem 1218 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for storing computer-readable information.

In certain embodiments, computer system 1200 may support virtualization technologies, including but not limited to virtualization of processing and memory resources. For example, computer system 1200 may provide support for executing one or more virtual machines. Computer system 1200 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computer system 1200. Accordingly, multiple operating systems may potentially be run concurrently by computer system 1200. Each virtual machine generally runs independently of the other virtual machines.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to establish a communication channel to one or more client devices via the Internet for receiving and sending information from and to the client devices. For example, adaptive webpages system 102 depicted in FIGS. 1 and 2 may receive user interactions information and webpage requests from client devices using communication subsystem 1224. Additionally, communication subsystem 1224 may be used to communicate webpages from adaptive webpages system 102 to the requesting clients.

Communication subsystem 1224 may support both wired and/or wireless communication protocols. For example, in certain embodiments, communications subsystem 1224 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

Communication subsystem 1224 can receive and transmit data in various forms. For example, in some embodiments, in addition to other forms, communications subsystem 1224 may receive input communication in the form of structured and/or unstructured data feeds 1226, event streams 1228, event updates 1230, and the like. For example, communications subsystem 1224 may be configured to receive (or send) data feeds 1226 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 1224 may be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to communicate data from computer system 1200 to other computer systems or networks. The data may be communicated in various different forms such as structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 1200 depicted in FIG. 12 is intended only as a specific example. Many other configurations having more or fewer components than the system depicted in FIG. 12 are possible. Based on the disclosure and teachings provided herein, a person of ordinary skill in the art will appreciate other ways and/or methods to implement the various embodiments.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation such as by executing computer instructions or code, or any combination thereof. Processes can communicate using a variety of techniques including but not limited to conventional techniques for interprocess communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims.

What is claimed is:

1. A method comprising:
identifying, by a computer system, a first user corresponding to a first document request, the first document request requesting a document, the document comprising an element;
determining, by the computer system, first user interactions information for a first plurality of users, the first user interactions information indicative of one or more prior interactions with the document by one or more users from the first plurality of users, the first plurality of users including the first user;
determining, by the computer system, based upon the first user interactions information, a first modification to be made to the document, the first modification including associating a first value with the element;
generating, by the computer system, a first modified version of the document in which the first value is associated with the element; and
causing, by the computer system, the first modified version of the document to be communicated as a response to the first document request.

2. The method of claim 1 wherein the element is an input field in the document.

3. The method of claim 1 wherein the document is a webpage and the first modified version of the document is a modified version of the webpage.

4. The method of claim 1 wherein the one or more users from the first plurality of users do not include the first user.

5. The method of claim 1 wherein determining the first modification to be made to the document comprises:
identifying, from the first user interactions information, a first usage pattern for the document for the first plurality of users; and
determining the first modification to be made to the document based upon the identified first usage pattern.

6. The method of claim 1 further comprising:
identifying, by the computer system, a second user corresponding to a second document request, the second request requesting the document;
determining, by the computer system, second user interactions information for a second plurality of users different from the first plurality of users, the second user interactions information indicative of one or more prior interactions with the document by one or more users from the second plurality of users, the second plurality of users including the second user;
determining, by the computer system, based upon the second user interactions information, a second modification to be made to the document, the second modification being different from the first modification, the second modification including associating a second value with the element, the second value being different from the first value;
generating, by the computer system, a second modified version of the document comprising the second modification; and
causing, by the computer system, the second modified version of the document to be communicated as a response to the second document request.

7. The method of claim 6:
wherein determining the first modification to be made to the document comprises:
identifying, from the first user interactions information, a first usage pattern for the document for the first plurality of users; and
determining the first modification to be made to the document based upon the identified first usage pattern; and
wherein determining the second modification to be made to the document comprises:
identifying, from the second user interactions information, a second usage pattern for the document for the second plurality of users, wherein the second usage pattern is different from the first usage pattern; and
determining the second modification to be made to the document based upon the identified second usage pattern.

8. A non-transitory computer-readable storage memory storing a plurality of instructions executable by one or more processors, the plurality of instructions comprising:
instructions that cause the one or more processors to identify a first user corresponding to a first document request, the first document request requesting a document, the document comprising an element;
instructions that cause the one or more processors to determine first user interactions information for a first plurality of users, the first user interactions information indicative of one or more prior interactions with the document by one or more users from the first plurality of users, the first plurality of users including the first user;
instructions that cause the one or more processors to determine, based upon the first user interactions information, a first modification to be made to the document, the first modification including associating a first value with the element;
instructions that cause the one or more processors to generate a first modified version of the document in which the first value is associated with the element; and
instructions that cause the one or more processors to cause the first modified version of the document to be communicated as a response to the first document request.

9. The non-transitory computer-readable storage memory of claim 8 wherein the element is an input field in the document.

10. The non-transitory computer-readable storage memory of claim 8 wherein the document is a webpage and the first modified version of the document is a modified version of the webpage.

11. The non-transitory computer-readable storage memory of claim 8 wherein the one or more users from the first plurality of users do not include the first user.

12. The non-transitory computer-readable storage memory of claim 8 wherein the instructions that cause the one or more processors to determine the first modification to be made to the document comprise:
instructions that cause the one or more processors to identify, from the first user interactions information, a first usage pattern for the document for the first plurality of users; and
instructions that cause the one or more processors to determine the first modification to be made to the document based upon the identified first usage pattern.

13. The non-transitory computer-readable storage memory of claim 8 wherein the plurality of instructions further comprise:
instructions that cause the one or more processors to identify a second user corresponding to a second document request, the second request requesting the document;
instructions that cause the one or more processors to determine second user interactions information for a second plurality of users different from the first plurality of users, the second user interactions information indicative of one or more prior interactions with the document by one or more users from the second plurality of users, the second plurality of users including the second user;
instructions that cause the one or more processors to determine, based upon the second user interactions information, a second modification to be made to the document, the second modification being different from the first modification, the second modification including associating a second value with the element, the second value being different from the first value;
instructions that cause the one or more processors to generate a second modified version of the document comprising the second modification; and
instructions that cause the one or more processors to cause the second modified version of the document to be communicated as a response to the second document request.

14. The non-transitory computer-readable storage memory of claim 13:
wherein the instructions that cause the one or more processors to determine the first modification to be made to the document comprise:
instructions that cause the one or more processors to identify, from the first user interactions information, a first usage pattern for the document for the first plurality of users; and
instructions that cause the one or more processors to determine the first modification to be made to the document based upon the identified first usage pattern; and
wherein the instructions that cause the one or more processors to determine the second modification to be made to the document comprise:
instructions that cause the one or more processors to identify, from the second user interactions information, a second usage pattern for the document for the second plurality of users, wherein the second usage pattern is different from the first usage pattern; and
instructions that cause the one or more processors to determine the second modification to be made to the document based upon the identified second usage pattern.

15. A system comprising:
one or more processors; and
a memory coupled with and readable by the one or more processors, the memory configured to store first user interactions information for a first plurality of users and second user interactions information for a second plurality of users, the first user interactions information indicative of one or more prior interactions with a document by one or more users from the first plurality of users, the second user interactions information indicative of one or more prior interactions with the document by one or more users from the second plurality of users, the document comprising an element;
the memory further configured to store a set of instructions which, when executed by the one or more processors, causes the one or more processors to:
responsive to a first document request for the document, determine, based upon the first user interactions information, a first modification to be made to the document, the first modification including associating a first value with the element;
generate a first modified version of the document comprising the first modification, wherein the first value is associated with the element; and
cause the first modified version of the document to be communicated as a response to the first document request.

16. The system of claim 15 wherein the element is an input field in the document.

17. The system of claim 15 wherein the set of instructions further comprises instructions, which when executed by the one or more processors, cause the one or more processors to:
identify, from the first user interactions information, a first usage pattern for the document for the first plurality of users; and
determine the first modification to be made to the document based upon the identified first usage pattern.

18. The system of claim 15 wherein the set of instructions further comprises instructions, which when executed by the one or more processors, cause the one or more processors to:
responsive to a second document request for the document, determine based upon the second user interactions information, a second modification to be made to the document, the second modification being different from the first modification;
generate a second modified version of the document comprising the second modification; and
cause the second modified version of the document to be communicated as a response to the second document request.

19. The system of claim 18 wherein the set of instructions further comprises instructions, which when executed by the one or more processors, cause the one or more processors to:
identify, from the first user interactions information, a first usage pattern for the document for the first plurality of users;
determine the first modification to be made to the document based upon the identified first usage pattern;
identify, from the second user interactions information, a second usage pattern for the document for the second plurality of users, the second usage pattern being different from the first usage pattern; and
determine the second modification to be made to the document based upon the identified second usage pattern.

20. A method comprising:
identifying, by the computer system, a first user corresponding to a first document request, the first document request requesting a document, the document comprising a plurality of tabs with a first tab from the plurality of tabs being selected;
determining, by the computer system, first user interactions information for a first plurality of users, the first user interactions information indicative of one or more prior interactions with the document by one or more users from the first plurality of users, the first plurality of users including the first user;
determining, by the computer system, based upon the first user interactions information, a first modification to be made to the document, the first modification including selecting a second tab from the plurality of tabs instead of the first tab;
generating, by the computer system, a modified version of the document in which the second tab from the plurality of tabs is selected instead of the first tab; and
causing, by the computer system, the modified version of the document to be communicated as a response to the first document request.
